(19) United States
(12) Patent Application Publication
(10) Pub. No.: US 2026/0300089 A1
(43) Pub. Date: Oct. 1, 2026

(54) ARTIFICIAL INTELLIGENCE MODEL ON SILICON WITH ERROR-CORRECTING CODE LOGIC

(71) Applicant: Intel Corporation, Santa Clara, CA (US)

(72) Inventors: Yaron Klein, Rosh Haayin (IL); Dan Horovitz, Rishon LeZion (IL); Yuval Vered, Tel-Aviv (IL); Yoni Elron, Hadera (IL)

(73) Assignee: Intel Corporation, Santa Clara, CA (US)

(21) Appl. No.: 19/536,695

(22) Filed: Feb. 11, 2026

Related U.S. Application Data
(60) Provisional application No. 63/781,796, filed on Apr. 1, 2025.
(60) Provisional application No. 63/782,347, filed on Apr. 2, 2025.

(51) Int. Cl. G06F 11/10; G06N 3/084

(52) U.S. Cl. CPC G06F 11/1048; G06F 11/1008; G06F 11/1012; G06F 11/1068; G06N 3/084

(57) ABSTRACT

A neural network model, e.g., a large language model, may be embedded into an apparatus including a memory layer and a logic layer. The memory layer stores encrypted data of the model, e.g., encrypted weights or tokens, and layer-specific decryption keys. The logic layer may include an ECC module and compute units. When data of a layer is written into a memory bank, the ECC module may generate an ECC codeword from the data, decrypt the ECC codeword with layer decryption key(s), and write the decrypted ECC codeword into the memory bank. When the data is read from the memory bank, the ECC module may detect or correct error(s) in the data based on the decrypted ECC codeword. The decrypted ECC codeword may be transmitted from the register to the decoder through a plurality of clock cycles. One or more compute units may perform multiply-accumulation operations on the corrected data.

### CROSS-REFERENCE TO RELATED APPLICATIONS

This application claims the benefit of U.S. Provisional Patent Application No. 63/781,796, filed Apr. 1, 2025 and titled “ERROR-CORRECTING CODE ENABLED EMBEDDING ARCHITECTURE FOR NEAR MEMORY TO LARGE LANGUAGE MODEL PROCESSING ON SILICON,” and U.S. Provisional Patent Application No. 63/782,347, filed Apr. 2, 2025 and titled “SECURING ARTIFICIAL INTELLIGENCE MODEL WEIGHTS IN MEMORY ERROR-CORRECTING CODES MECHANISM,” each of which is incorporated herein by reference in its entirety for all purposes.

### TECHNICAL FIELD

This disclosure relates generally to artificial intelligence (AI), and more specifically, AI model on silicon with error-correcting code (ECC) logic.

### BACKGROUND

Neural networks (also referred to as “deep neural networks” or “DNNs”) are used extensively for a variety of AI applications, including but not limited to natural language processing, computer vision, speech recognition, and image processing, due to their ability to achieve high accuracy. However, the high accuracy comes at the expense of significant computation cost. DNNs have extremely high computing demands as there can be a large number of operations as well as a large amount of data to read and write. Therefore, techniques to improve efficiency of DNNs are needed.

### BRIEF DESCRIPTION OF THE DRAWINGS

Embodiments can be readily understood by the following detailed description in conjunction with the accompanying drawings. To facilitate this description, like reference numerals designate like structural elements. Embodiments are illustrated by way of example, and not by way of limitation, in the figures of the accompanying drawings.

Figure (FIG. 1 illustrates an integrated circuit (IC) device that implements a model on silicon, in accordance with various embodiments.

FIG. 2 illustrates an inference process of a DNN model, in accordance with various embodiments.

FIG. 3 illustrates an integrated memory-compute system, in accordance with various embodiments.

FIG. 4 illustrates an ECC module, in accordance with various embodiments.

FIG. 5 illustrates an ECC flow, in accordance with various embodiments

FIG. 6 illustrates an ECC module capable of data decryption, in accordance with various embodiments.

FIG. 7 illustrates a multi-die encryption scheme within a DNN inference system, in accordance with various embodiments.

FIG. 8 illustrates an integrated system with ECC-key integration, in accordance with various embodiments.

FIG. 9 illustrates a perspective view of a three-dimensional (3D) integrated system, in accordance with various embodiments.

FIG. 10 is a flowchart showing a method of DNN inference, in accordance with various embodiments.

FIG. 11 is a block diagram of an example computing device, in accordance with various embodiments.

### DETAILED DESCRIPTION

The last decade has witnessed a rapid rise in AI-based data processing, particularly based on DNNs. DNNs are widely used in various domains (e.g., language processing, computer vision, speech recognition, autonomous driving, image processing, video processing, etc.) mainly due to their ability to achieve beyond human-level accuracy. A DNN typically includes a sequence of layers. A DNN layer may include one or more deep learning operations (also referred to as “neural network operations”), such as embedding operation, MatMul operation, layer normalization, batch normalization, activator operations (e.g., SoftMax operation, etc.), pooling, elementwise operation, linear operation, nonlinear operation, and so on.

Neural network operations may be tensor operations. Input or output data of neural network operations may be arranged in data structures called tensors. Taking a convolutional layer for example, the input tensors include an activation tensor (also referred to as “input feature map (IFM)” or “input activation tensor”) including one or more activations (also referred to as “input elements”) and a weight tensor. The weight tensor may be a kernel (a two-dimensional (2D) weight tensor), a filter (a 3D weight tensor), or a group of filters (a four-dimensional (4D) weight tensor). A convolution may be performed on the input activation tensor and weight tensor to compute an output activation tensor in the convolutional layer.

A tensor is a data structure having multiple elements across one or more dimensions. Examples of tensors include vector (which is one-dimensional (1D) tensor), matrix (which is 2D tensor), 3D tensors, 4D tensors, and even higher dimensional tensors. A dimension of a tensor may correspond to an axis, e.g., an axis in a coordinate system. A dimension may be measured by the number of data points along the axis. The dimensions of a tensor may define the shape of the tensor. A DNN layer may receive one or more input tensors and compute an output tensor from the one or more input tensors. In some embodiments, a 3D tensor may have an X-dimension, a Y-dimension, and Z-dimension. The X-dimension of a tensor may be the horizontal dimension, the length of which may be the width of the tensor; the Y-dimension may be the vertical dimension, the length of which may be the height of the tensor; and the Z-dimension may be the channel dimension, the length of which may be the number of channels. The coordinates of the elements along a dimension may be integers in an inclusive range from 0 to (L−1), where L is the length of the tensor in the dimension. For instance, the x coordinate of the first element in a row may be 0, the x coordinate of the second element in a row may be 1, and so on. Similarly, the y coordinate of the first element in a column may be 0, the y coordinate of the second element in a column may be 1, and so on. A 4D tensor may have a fourth dimension, which may indicate the number of batches in the operation.

For large language model (LLM) inference, especially in transformer-based architectures, usually all model weights are accessed for each token generation. Because dynamic random-access memory (DRAM) typically requires data to be written back immediately after each read, single-bit errors can accumulate every time memory is cycled through. Even a small per-read error rate can translate into multiple errors over hundreds of tokens, causing an unacceptable level of data corruption and a noticeable drop in model accuracy.

Currently available solutions based on general-purpose graphics processing units (GPGPUs) or accelerators usually rely on external memory error correction capabilities like ECC implementations. Yet for solutions that do not rely on external memory but use internal in silicon memory near compute, this may not be possible. A technical challenge is to maintain near-memory computing with large on-chip DRAM footprints—where entire memory banks are accessed multiple times per token—without accruing data errors that degrade inference quality.

Many currently available approaches are GPU-based approaches. A widely adopted strategy for running LLM inference is to use standard GPGPUs. These typically rely on external DRAM equipped with ECC, which helps prevent single-bit errors from accumulating during repeated reads. Under this model, data is loaded from ECC-protected external memory for each inference request. While this can mitigate the risk of progressive data corruption, it does not work for internal DRAM solutions.

Near-memory compute in other domains is another approach, observed in certain cryptographic accelerators, that positions computation logic close to the memory. However, these designs typically rely on external or frequent memory refresh cycles to maintain data integrity. In smaller-scale applications—such as some crypto solutions—this refresh strategy helps limit data corruption. Yet for LLM inference, where usually the entire on-chip DRAM arrays are accessed repeatedly for every token, a refresh-based method is not practical. Large near-memory DRAM banks can cycle through data hundreds of times per inference sequence, quickly accumulating single-bit errors when ECC or frequent external refreshes are unavailable. Consequently, accuracy can suffer, and the benefits of near-memory compute can diminish.

Furthermore, many AI models can reach or exceed one trillion parameters and pose a significant challenge for real-time encryption and decryption, especially when deployed on edge devices. Existing solutions (e.g., simple encryption or software-based license checks) do not provide a reliable, hardware-level mechanism to ensure that licensed or paid-for models are loaded and that the model memory itself remains unaltered. While ECC can detect and correct bit errors, they do not inherently authenticate the model or enforce monetization. As a result, AI creators can risk unauthorized usage, tampering, and loss of revenue when proprietary models are deployed outside secure data centers.

Typically, a frontier lab or organization that develops AI models (including LLMs) has virtually no control over how their models are loaded and run on edge devices, which is a reason why these models are usually not used outside of secure data centers. In particular, there is no reliable mechanism at the hardware level to verify whether the deployed model is either licensed or being paid for its use. Existing solutions, such as simple encryption or basic software-based license checks, do not offer comprehensive protection against unauthorized model loading or tampering on the edge. Furthermore, although ECC in hardware can detect and correct bit flips, they do not inherently provide a secure mechanism to validate that the model in memory is authorized or that its usage has been monetized correctly. This situation leads to critical vulnerabilities—for example, a malicious actor could run or redistribute a proprietary model without compensating its original creators. Additionally, ensuring the confidentiality of AI models is paramount. The models often encapsulate proprietary algorithms and represent significant intellectual property. Unauthorized access to these models can lead to the exposure of sensitive information and compromise the competitive edge of the model creators.

A variety of solutions have been used to protect data integrity or secure proprietary models in memory. A solution is ECC without encryption. In traditional memory systems, ECC are used to detect and correct single-bit (or sometimes multi-bit) errors. While ECC ensures data reliability protecting against bit flips caused by hardware faults it does not prevent unauthorized access to the underlying (plaintext) data. A machine-learning model provider might sell licenses to its model, storing the model in memory with ECC protection to guard against corruption. However, anyone with direct memory access can still copy the unencrypted model, defeating the provider's attempt to monetize its intellectual property. Although ECC solves reliability issues, it lacks any encryption mechanism. Hence, it offers no defense against unauthorized reads of the model.

Another solution is based on software-level encryption libraries. Some systems rely on software (e.g., user-mode libraries, operating-system encryption features, etc.) to encrypt data at rest or in transit. A model provider might distribute a “locked” application that decrypts the model in memory. However, keys reside in software, so a well-resourced attacker could reverse-engineer or hook into the software to extract the plaintext model or the key at runtime. Software-based encryption can be bypassed when attackers gain debug-level or kernel-level privileges. It can also introduce overhead and complexity, as data repeatedly travels between central processing unit (CPU) registers/software encryption layers and memory.

Yet another solution is using dedicated encryption hardware that is separate from ECC. This solution is to funnel all memory reads/writes through a dedicated encryption engine that operates independently of ECC logic. This hardware typically encrypts data blocks before they are sent off-chip, decrypting them at retrieval time. A provider may rely on a separate hardware security module (HSM) that stores a model in encrypted form. The idea is to keep encryption secluded. However, the ECC portion remains separate, so the data is not corrected in its encrypted form leading to possible mismatches or additional overhead for re-encrypting corrected data. Since ECC is not integrated with encryption, there can be conflict or overhead whenever single-bit errors occur. The system needs to correct, re-encrypt, and manage additional synchronization steps, which degrades performance and increases complexity.

Yet another solution is using black-box embedded systems with ECC (without keys). In some cases, a black-box hardware module is provided with an embedded model and ECC logic to keep reliability high. The module might physically hide or obfuscate the internal structure so that unauthorized users cannot easily tamper with it. However, it generally does not embed a robust encryption scheme alongside ECC often data is stored in partial plaintext or obfuscated form. A hardware vendor might embed a machine-learning model in a chip and distribute it to customers. Because ECC is used for error correction, a determined attacker could still dump the memory contents after the module is powered up and extract the model. Even though the module is “black box,” memory contents can often be probed by advanced methods or with invasive access to the hardware. Without true encryption integrated into ECC, the data is still vulnerable to exfiltration.

Embodiments of this disclosure may improve on at least some of the challenges and issues described above by providing AI model on silicon with ECC logic capable of both error correction and data decryption. In an example, inference of an encrypted DNN model may be embedded into wafer-bonded memory and logic dies. The dies may be coupled with one or more ECC modules. The ECC module(s) may be integrated at the memory interface. Encrypted data of the model and decryption keys may be stored in the memory die. The ECC module(s) may decrypt the encrypted data using the decryption keys and mitigate single-bit errors in the data. This system can deliver high efficiency by performing vector operations directly adjacent to each memory bank (e.g., 1 MB DRAM bank) while continuously decrypting and correcting data in real time. Integration of ECC at the memory interface can ensure reliability without significantly impacting throughput or accuracy.

In various embodiments of this disclosure, an apparatus for DNN inference may include a memory layer and a logic layer. The memory layer may include memory banks. The memory layer may store encrypted data of a DNN model, such as encrypted weights or tokens. The model may be encrypted by segmenting the model into layers and encrypting the layers with layer-specific keys. The memory layer may also store the layer-specific keys, which may be layer decryption keys. The logic layer may include an ECC module and compute units. The ECC module may integrate an ECC mechanism with a decryption mechanism. The ECC module may include an encoder, a register, and a decoder. When data of a layer of the model is written into a memory bank, the encoder may generate parity bits by performing XOR operations on the data and combine the parity bits with the bits of the data to generate an ECC codeword. The encoder may further decrypt the ECC codeword with the layer decryption key(s) and write the decrypted ECC codeword into the memory bank. When the data is read from the memory bank, the decoder may detect or correct one or more errors in the data based on the decrypted ECC codeword. The decrypted ECC codeword may be transmitted from the register to the decoder through a pipeline having a plurality of clock cycles. In an example where the ECC codeword has 72 bits, the pipeline may have 72 clock cycles. A compute unit coupled with the memory bank may perform multiply-accumulation operations on the corrected data.

This disclosure provides a secure, high-performance architecture for both encrypting/decrypting large datasets (such as machine-learning models) and simultaneously protecting them with ECC. By integrating encryption keys directly into the ECC process, this approach can ensure data integrity and confidentiality with minimal performance overhead. It can improve accuracy for large-scale LLM workloads. The architecture(s) disclosed herein can boost LLM inference performance by minimizing data movement and ensuring real-time error correction in memory-intensive operations. It can provide a more reliable, power-efficient architecture for large-scale AI workloads. As a result, users can benefit from faster inference speeds, reduced error rates, and consistent accuracy even at massive scale.

By tightly integrating cryptographic keys such as encryption keys within ECC, the approach in this disclosure can enable fast on-the-fly decryption of neural-network weights while preserving integrity and confidentiality. On each load, the encryption key may be refreshed providing a moving target encryption that further complicates attacks by regularly updating encryption parameters. Customers can securely and efficiently monetize valuable intellectual property while safeguarding high-value data against unauthorized access. This approach can provide security with a negligible performance impact.

Integrating cryptographic measures within ECC processes can not only verify integrity but also encrypt the data, shielding it from unauthorized access and tampering. This integrated security approach can ensure that the AI model remains confidential throughout its lifecycle, thereby protecting the investment and innovation of its developers. There is a need for a combined hardware and cryptographic solution that not only corrects random memory errors but also enforces real-time authentication of the AI model and can verify paid or licensed usage. By embedding a verifiable key and secure checking mechanism into the ECC process itself, the system can prevent unauthorized models from being run on edge devices, ensure correct operation of the intended model, and provide a pathway for monetization of AI model usage. Furthermore, this integrated approach can ensure that the model's confidentiality is maintained throughout its lifecycle. Cryptographic signatures applied to memory blocks can not only verify integrity but also safeguard the model against unauthorized access and tampering. This can prevent sensitive AI algorithms from being exposed or leaked, preserving the proprietary nature of the model and protecting intellectual property rights.

For purposes of explanation, specific numbers, materials and configurations are set forth in order to provide a thorough understanding of the illustrative implementations. However, it can be apparent to one skilled in the art that the present disclosure may be practiced without the specific details or that the present disclosure may be practiced with only some of the described aspects. In other instances, well known features are omitted or simplified in order not to obscure the illustrative implementations.

Further, references are made to the accompanying drawings that form a part hereof, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A or B” or the phrase “A and/or B” means (A), (B), or (A and B). For the purposes of the present disclosure, the phrase “A, B, or C” or the phrase “A, B, and/or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations are described using terms commonly employed by those skilled in the art to convey the substance of their work to others skilled in the art.

The terms “substantially,” “close,” “approximately,” “near,” and “about,” generally refer to being within +/−20% of a target value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value as described herein or as known in the art.

In addition, the terms “comprise,” “comprising,” “include,” “including,” “have,” “having” or any other variation thereof, are intended to cover a non-exclusive inclusion. For example, a method, process, device, or DNN accelerator that comprises a list of elements is not necessarily limited to only those elements but may include other elements not expressly listed or inherent to such method, process, device, or DNN accelerators. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description below and the accompanying drawings.

FIG. 1 illustrates an IC device 100 that implements a model on silicon, in accordance with various embodiments. In some embodiments, the IC device 100 may be a hardware implementation of a DNN. An example of the DNN is a transformer-based model, such as a LLM. At least part of the model architecture, weights, and flow of the DNN can be embedded into the IC device 100. For instance, the IC device 100 may include memories that store the weights of the DNN. The IC device 100 may also include compute units that are mapped to the operators in the DNN. In some embodiments, the IC device 100 may be a chip, such as a silicon chip.

As shown in FIG. 1, the IC device 100 includes a flow control unit 111, tokenizer unit 112, embedder unit 113, root mean square (RMS) normalizer unit 114, rotary embedder unit 115, Sigmoid linear unit (SiLU) unit 116, SoftMax unit 117, sampler unit 118, embedding dot unit 120, and attention dot unit 130. A unit in the IC device 100 may be a circuit or may include multiple circuits. In other embodiments, the IC device 100 may include fewer, more, or different components. For example, the IC device 100 may include more than one flow control unit 111, tokenizer unit 112, embedder unit 113, RMS normalizer unit 114, rotary embedder unit 115, SiLU unit 116, SoftMax unit 117, sampler unit 118, embedding dot unit 120, or attention dot unit 130. As another example, the units may be arranged in fewer, more, or different dies of the IC device 100. Further, functionality attributed to a component of IC device 100 may be accomplished by a different component included in the IC device 100 or a different device.

The flow control unit 111 manages data flow between various components of the IC device 100. In some embodiments, the flow control unit 111 plays a role in orchestrating various components (e.g., units) of the IC device 100 to execute operations according to a predetermined timing sequence. The flow control unit 111 may also be referred to as a sequencer unit, which can orchestrate one or more other components of the IC device 100 according to a predetermined timing sequence of the DNN. In an example, the flow control unit 111 may control and ensure that the tokenizer unit 112 converts input tokens and passes them to the embedding sections, such as the embedder unit 113, the rotary embedder unit 115, and embedding dot unit 120; the embeddings are then processed and passed to the attention dot unit 130 for attention computation; the attention results are then normalized by the RMS normalizer unit 114, activated by the SiLU unit 116, and passed through the SoftMax unit 117 to generate output probabilities; finally, the sampler unit 118 samples from the output distribution and generates the final output tokens.

In some embodiments, the DNN operates in a feedforward manner. In an example, the DNN may include a sequence of layers. A layer may have one or more operators. For a layer having multiple operators, the operators may be arranged in the sequence. Each operator may correspond to a neural network operation. For example, a MatMul operator specifies a MatMul operation. The sequence of all the operators in the DNN may be predetermined as a part of the model architecture of the DNN. In some embodiments, the spatial shape of the input tensor(s) and output tensor of an operator can also be predetermined. During inference, data flows through the operators in the DNN in the predetermined sequence. The predetermined sequence of the operators in the DNN can be mapped into a timing sequence of various components of the IC device 100 executing the corresponding neural network operations. The timing sequence of neural network operations may include stages of operations, one following another. In a particular time slot or stage in the timing sequence, data can be moved in, processed, and moved out to be processed in the next/following time slot, in a feedforward, progressive manner.

In some embodiments, the flow control unit 111 may implement digital logic to generate clock edges/signals (e.g., control signals, timing signals, enable signals, disable signals, trigger signals, etc.) to orchestrate operations to be performed according to the timing sequence. The flow control unit 111 may control data flow into or out of one or more other components of the IC device 100. The flow control unit 111 may also enable or disable one or more other components of the IC device 100 according to a predetermined timing sequence.

The tokenizer unit 112 is a hardware implementation of a tokenizer in the DNN. In an example, the tokenizer unit 112 is a hardware-based tokenizer for a DNN. The tokenizer unit 112 may convert raw data (e.g., words) to tokens. For instance, the tokenizer unit 112 may use the DNN's vocabulary to convert works received from a user to tokens that can be further processed by other operators in the DNN. The vocabulary may be predefined vocabulary. In some embodiments, the vocabulary of the DNN is implemented on the tokenizer unit 112. For instance, the vocabulary may be stored in a data storage unit of the tokenizer unit 112. The tokenizer unit 112, after receiving words, may compare the words with the vocabulary to determine indices of tokens corresponding to the words. The tokenizer unit 112 may output the token indices.

In some embodiments, the tokenizer unit 112 includes a cycle buffer, comparator, memory, ID block, and multiplexer (MUX). The cycle buffer may receive and store data received by the tokenizer unit 112. The data may be the input data of the DNN. The input data may be one or more words that need to be tokenized. In some embodiments, the tokenizer unit 112 may have a different type of data storage unit from the cycle buffer for storing input data. The comparator retrieves input data from the cycle buffer and compares the word(s) with the vocabulary of the DNN. The vocabulary of the DNN is stored in the memory. The memory may be a read-only memory (ROM), such as a sequential ROM. The memory may store a list of vocabulary entries, which are predefined words or tokens. Each vocabulary entry corresponds to a unique Token ID. The ID block stores the Token IDs associated with each vocabulary entry. When the comparator finds a match in the vocabulary, the ID block receives the corresponding Token ID. After a Token ID is retrieved, it is output through the ID block. The comparator may access the vocabulary in the memory to find a match for each word in the input data. When a match is found, the corresponding Token ID is fetched from the ID block and provided to the MUX. The MUX may output the Token ID as an output of the tokenizer unit 112. In some embodiments, the output of the Token ID from the MUX may be controlled by a signal from the comparator. The signal may indicate that a match has been found.

The embedder unit 113 may implement an embedder (e.g., an embedding layer) of the DNN. The embedder unit 113 may execute the embedding layer to convert tokens (such as tokens generated by and received from the tokenizer unit 112) to embedding vectors. In some embodiments, the embedder unit 113 may include look-up tables that map tokens to embedding elements. The look-up tables may output embedding elements corresponding to input tokens. The embedding elements may constitute the embedding vector of the input tokens.

In an example, the embedder unit 113 includes 256 look-up tables. The look-up tables may have the same storage size, e.g., 1000 KB. Each of the look-up tables may have 112,000 lines. In some embodiments, the look-up tables may be implemented on one or more ROMs. In an example, the 256 look-up tables are implemented on 256 ROMs, respectively. The embedder unit 113 may receive an input token. In the example shown in FIG. 1, the embedder unit 113 receives an input token represented by 15 bits. The input token may have an integer format. The embedder unit 113 may also receive control signals. For instance, the embedder unit 113 receives an embedder cycle signal, which may have 10 bits. The embedder unit 113 also receives an embedder run signal, which may have 1 bit. The embedder unit 113 may also receive an embedder on/off signal, which may have 1 bit.

The output of the embedder unit 113 may be an embedding vector. For instance, the embedder unit 113 may produce an embedding vector with floating-point (e.g., FP16) data elements. The dimension of the embedding vector may indicate the total number of data elements in the embedding vector. In an example, the dimension of the embedding vector may be 10,096. In some embodiments, the embedder unit 113 may receive 32,000 tokens. The total embedder size may be 250 megabytes (MB), which equals 10, 096×32,000×2B. Each of the tokens in the vocabulary may be broken into 16 chunks of 256 numbers. In some embodiments (e.g., embodiments where the look-up tables are stored in ROMs), the first out of 16 numbers may be read from the table. Reading from the ROM may be sequential for 16 cycles, so the next line is to be pre-charged but it may be unnecessary to pre-charge other lines. Within each cycle, the 256 look-up tables may output 256 embedding vector elements, respectively. The embedder unit 113 may return 256 elements every clock cycle for 16 clocks cycles. After finishing the 16 cycles, the embedder unit 113 may be idle for about 10,000 cycles. Power gating may be used.

The RMS normalizer unit 114 may normalize data using RMS normalization. The RMS normalizer unit 114 may implement one or more RMS normalizer functions in the DNN. An RMS normalizer function may be denoted as:

$$\frac{{x}_{i} \cdot {W}_{{RMS}_{i}}}{\sqrt{\frac{{\sum }_{j = 0}^{4 , 096} {x}_{j}^{2}}{4 , 096} + {10}^{- 5}}}$$

In some embodiments, the RMS normalizer unit 114 may receive an input vector (e.g., 4096 FP16 elements) and return an RMS-normalized vector (e.g., 4096 elements in FP8 format). The RMS normalizer unit 114 may receive 256 elements every clock for 16 clocks cycles. The RMS normalizer unit 114 may include tree adder 1502 to add a number of values (e.g., 256 values) together simultaneously. The RMS normalizer unit 114 may include ROM 1504 storing a look-up table comprising one or more precomputed values of the function:

$$f ( x ) = {\sqrt{\frac{x}{4 , 096} + {10}^{- 5}}}^{- 1} .$$

The rotary embedder unit 115 may apply rotary positional embeddings on input data. The rotary embedder unit 115 is the hardware implementation of one or more rotary position encoders in the DNN. The rotary embedder unit 115 may produce rotary positional encoded embeddings. In some embodiments, the rotary embedder unit 115 may provide the functionality of a sine cosine unit without the need to calculate/compute sine and cosine in real-time. The rotary embedder unit 115 may have a sine cosine unit that has a look-up table implementation. In some embodiments, the rotary embedder unit 115 may include a look-up table comprising one or more precomputed values of a cosine function

$$( e . g . , f ( t ) = cos ( {10}^{- \frac{{h}_{n}}{16}} \cdot t ) ) .$$

The rotary embedder unit 115 may include another look-up table comprising one or more precomputed values of sine function

$$( e . g . , f ( t ) = sin ( {10}^{- \frac{{h}_{n}}{16}} \cdot t ) ) .$$

The SiLU unit 116 is a hardware implementation of one or more SiLU activators in the DNN. The SiLU unit 116 may include a look-up table having one or more precomputed values of a SiLU function:

$$f ( x ) = \frac{x}{1 + {e}^{- x}}$$

In some cases, the SiLU unit 116 includes a MUX controller and a MUX. The MUX controller may check whether the input value meets a particular condition and selects a particular value to use as the output of SiLU unit 116. The MUX controller may output a 2-bit value as selection signal for the MUX, to select one of three possible values to use as the output. For example, when the sign bit is 0 and the most-significant bits (MSBs) of the input are “11”, the input is selected by the MUX and passed on to use as the output. When the sign bit is 1 and the MSBs of the input are “11”, the value of “0” is selected by the MUX to use as the output. Otherwise, the value from the look-up table is used as the output.

The SoftMax unit 117 is a hardware implementation of one or more SoftMax activators in the DNN. The SoftMax unit 117 may implement a SoftMax function for output probability distribution. In some embodiments, the SoftMax unit 117 may execute a SoftMax function using one or more look-up tables that are pre-configured with precomputed data. The SoftMax function may be:

$$\frac{{e}^{\frac{{x}_{i} - {x}_{max}}{\sqrt{128}}}}{{\sum }_{j = 0}^{t} {e}^{\frac{{x}_{j} - {x}_{max}}{\sqrt{128}}}}$$

In some embodiments, the SoftMax unit 117 includes look-up table implementation of the SoftMax function instead of a compute-oriented solution. In some embodiments, the SoftMax unit 117 receives an input vector of t FP16 elements (1<t<512) and returns the SoftMax normalized vector of the same size. The SoftMax unit 117 receives 16 numbers per cycle for up to 32 cycles and returns 16 numbers per cycle for up to 32 cycles.

In an example, the SoftMax unit 117 receives an input vector including 16 elements, each of which is a FP16 value, in a clock cycle. The total number of bits of the input vector is 256. The SoftMax unit 117 may also receive a compare control signal, normalize control signal, exponent control signal, multiply control signal, on/off control signal, other types of control signals, or some combination thereof. A control signal may have 1 bit. The output of the SoftMax unit 117 may be 16 elements with UFP16 format. The total number bits may be 240. The SoftMax unit 117 may execute the SoftMax function using 16 clock cycles. Numbers may be stored in a first-in-first-out (FIFO) buffer while they are compared to find the largest number in the vector. The FIFO buffer may output numbers. The largest number may be subtracted. The subtraction result is provided to a look-up table. The output of the look-up table enters a second FIFO. Numbers may be pulled out of the second FIFO and multiplied by the normalization value. It may take a total of 24 cycles to compute the output. The 24 cycles may include 8 latency cycles and 16 piping cycles

In some embodiments, the SoftMax unit 117 may be included in the attention dot unit 131 to perform SoftMax on an input vector (e.g., FP16 vector) and to output a SoftMax-ed vector (e.g., FP16 vector). The SoftMax unit 117 may include a look-up table comprising one or more

$$f ( x ) = {e}^{\frac{x}{\sqrt{128}}} .$$

precomputed values of an exponent function: The SoftMax unit 117 may include another look-up table comprising one or more precomputed values of a reciprocal function: ƒ(x)=1/x. The SoftMax unit 117 may include a tree adder that can add a number of values (e.g., 18 values) together simultaneously.

The sampler unit 118 is a hardware implementation of one or more samplers in the DNN. The sampler unit 118 may sample from the output distribution. In some embodiments, the sampler unit 118 may receive an input vector and compare elements of the input vector to find the largest value. The sampler unit 118 may determine the index of the largest number and return a token. In some embodiments, the sampler unit 118 may receive a logits vector. In an example, the vector may include 32,000 elements. In some embodiments, the sampler unit 118 may receive 256 input elements for a cycle and may take 125 cycles to process the 32,000. The input elements may be in FP16 format. The total number of bits for the 256 input elements may be 4,096 bits. In some embodiments, the 256 input elements may be received from 256 MatMul units, such as 256 attention dot units, respectively. In some embodiments, the sampler unit 118 may implement a deterministic sampler having zero temperature. The sampler unit 118 may also receive control signals, such as an on/off signal indicating whether the sampler unit 118 is to be on or off, a restart signal indicating whether to restart the sampler unit 118, and a run signal. A control signal may have 1 bit. The sampler unit 118 may determine an index, such as a 32-bit index, corresponding to the largest number in the input vector. The index may correspond to an output token. In some embodiments, the output token may be a 15-bit integer.

In some embodiments, the sampler unit 118 includes 256 sampling comparators. In other embodiments, the sampler unit 118 may include a different number of sampling comparators. With the 256 sampling comparators, the sampler unit 118 can compare 256 input elements every clock cycle and keeps the index and value of the largest number. Each sampling comparator may compare two logits or values in a single clock cycle and return the larger number of its index (token). Each value may have 16 bits and may be in the FP16 format. The index (token) may be a 15-bit integer. The output may include the larger value as well as the index of the larger value. In a situation where more than one number has the largest value, the sampler unit 118 may return the token with the lowest index out of the equal tokens. When finishing the 125 clock cycles, the sampler unit 118 returns the token of the largest value in the input vector. For instance, the sampler unit 118 may output the index of the largest value in the input vector.

In some embodiments, the sampler unit 118 may have sampling comparators arranged in a tree or hierarchical structure to efficiently compare a large number of values (e.g., hundreds or thousands of values or more) simultaneously. For instance, each comparator in the first tier may compare two values in the input vector and select the larger value, each comparator in the second tier may compare two values from two comparators, respectively, in the first tier, each comparator in the third tier may compare two values from two comparators, respectively, in the second tier, and so on. The last tier may include a comparator that outputs the largest value of the input vector. In some embodiments, the sampler unit 118 may have a latency of 9 clock cycles. Every layer of comparators may be pipeline. In some embodiments, the sampler unit 118 may have power gating.

The embedding dot unit 120 is hardware implementation of embedding computations in the DNN. For instance, the embedding dot unit 120 may implement MatMul operators and add operators in the DNN, such as the MatMul operators and add operators in one or more encoders of the DNN. The embedding dot unit 120 may handle the initial embedding of tokens, performing matrix multiplications to transform input data into a suitable format for the DNN. The embedding dot unit 120 may convert input tokens into dense vector representations, which may be essential for subsequent processing in the DNN. In some embodiments, the embedding dot unit 120 are compute-in-memory units, which hold the static weights of the DNN. The static weights may be weights that do not change during inference of the DNN. The embedding dot unit 121 includes a plurality of multiply-add units 122 (individually referred to as “multiply-add unit 122”) and an add unit 123.

In some embodiments, the multiply-add units 122 may perform MatMul operations. A MatMul operation may be performed on a weight tensor and an activation tensor. The activation tensor may be the output of the previous operators in the DNN. Weight tensors may be stored in memory blocks associated with the multiply-add units 122. In some embodiments, the multiply-add units 122 may be associated with ROMs. Weight tensors used by the multiply-add units 122 may be stored in ROM blocks. The ROM blocks may be sequential ROM blocks. Sequence ROM is a type of memory storage, utilizing ROMs, that allows data to be read sequentially but not written or modified after the values have been etched onto the ROM. The rest of the ROM can be shut down to reduce power and area. This ROM-based design can ensure efficient storage and quick access to static weights, enhancing the speed and efficiency of embedding operations.

The attention dot unit 130 is hardware implementation of attention computations in the DNN. For instance, the attention dot unit 130 may implement MatMul operators and add operators in the DNN, such as the MatMul operators and add operators in one or more decoders of the DNN. The attention mechanism may be critical for understanding the relationships between different parts of the input sequence. The attention dot unit 130 may focus on the computation of attention scores and the weighted sum of value vectors, which may be critical for capturing dependencies and relationships between different parts of the input data. The attention dot unit 130 may be compute-in-memory dies. The attention dot unit 130 may utilize sequential RAM to handle the dynamic nature of attention computations. This sequential RAM-based design can allow for fast and efficient computation of attention scores, leveraging high memory bandwidth and low latency to optimize performance.

As shown in FIG. 1, the attention dot unit 131 includes a plurality of multiply-add units 132 (individually referred to as “multiply-add unit 132”) and an add unit 133. In some embodiments, each multiply-add unit 132 may include one or more multipliers and tree adders. In one implementation, a multiply-add unit 132 may carry out a (128-elements) dot product operation between FP16 input vector and FP16 K or V vector cached in one or more memory blocks, e.g., every cycle. The dot product operation can be performed using the one or more multipliers and one or more tree adders in the multiply-add unit 132. A multiplier may multiple two values, such as two floating-point values. In an example, the attention dot unit 131 one or more FP16/FP16 multipliers. A multiplier may be specifically designed to perform multiplication of data having predetermined representations (e.g., FP4, FP6, FP8, FP12, FP16, INT8, etc.). One or more multipliers in the attention dot unit 131 may receive data from one or more memory blocks. One or more tree adders may add multiplication results produced by one or more multipliers together.

The memory blocks can store and provide data to one or more circuits performing logic operations in the multiply-add units 132. In some embodiments, a multiply-add unit 132 may receive an input number and multiplies it by a number from the corresponding memory block in every clock cycle. The memory blocks may be RAM blocks, such as DRAM blocks. In some embodiments, a RAM may be a sequential read/write memory, such as a sequential read/write static random-access memory (SRAM). A sequential read/write memory can be used with or in an attention dot unit to supply weights to a multiplier in the multiply-add unit 132. A RAM that can be read sequentially or written sequentially may have drastically simplified logic and circuitry for reads or writes. The RAM may be used in a special configuration where it is not dynamically readable but is built up sequentially to reduce power and area.

In some embodiments, a RAM of a multiply-add unit 132 may be placed in proximity to the circuits performing logic operations in the multiply-add unit 132. The RAM may store intermediate values of the DNN. The intermediate values may be dynamic during the DNN inference, meaning their values may change. For instance, the RAM may store a key-value (KV) cache. New keys or values may be written into the RAM as they are generated. The RAM may be referred to as KV RAM. In embodiments where the RAM is a SRAM, it may be referred to as a KV SRAM. KV RAM can enable storing the attention history (e.g., cached keys and values) of a transformer block. In an exemplary implementation, 64 SRAMs may be used to store the 32 layers and K vs. V separately, so the SRAM can read lines sequentially. The tree adders in the multiply-add units 132 may add multiplication results produced by the multipliers together. A tree adder may also be referred to as an adder tree and may include adders arranged in a tree structure. The add unit 133 may add outputs of the multiply-add units 132.

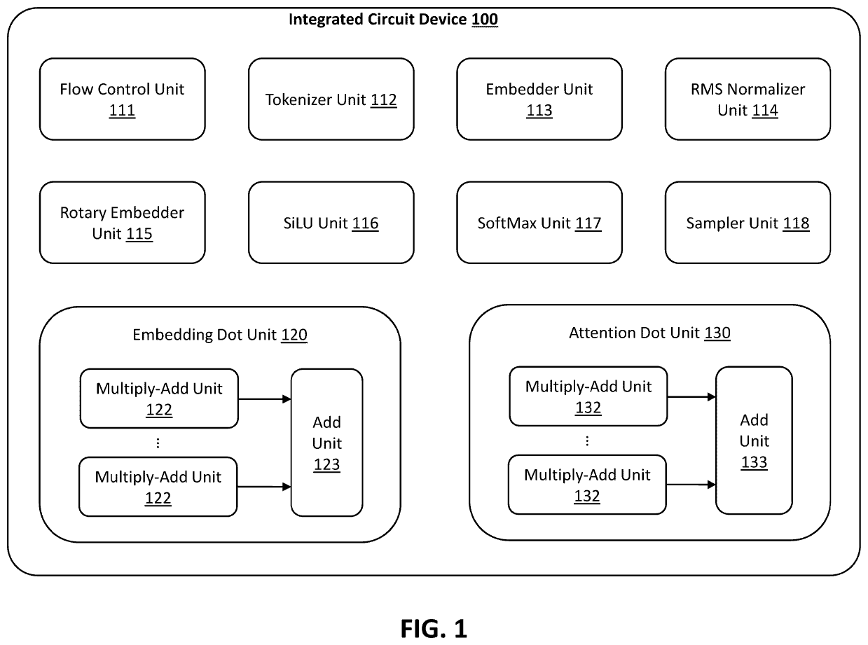

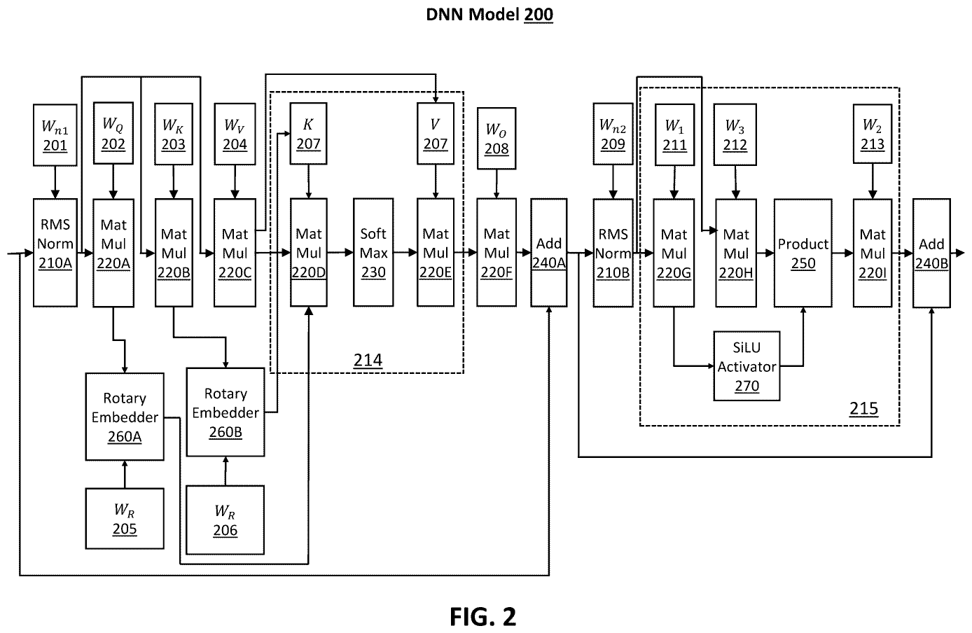

FIG. 2 illustrates an inference process of a DNN model 200, in accordance with various embodiments. In the embodiment of FIG. 2, the DNN model 200 is a transformer-based model. For instance, the DNN model 200 may be LLM, speech recognition model, and so on. The DNN model 200 may process input embeddings through a series of highly optimized neural network operations to generate output. The DNN model 200 may be embedded on an IC device, such as the IC device 100 in FIG. 1. For instance, the weights of the DNN model 200 may be stored in memories of the IC device 100, and operators in the DNN model 200 may be mapped to compute units of the IC device 100.

As shown in FIG. 2, the DNN model 200 includes RMS normalizers 210A and 210B, MatMul operators 220A-220I, SoftMax activator 230, add operators 240A and 240B, product operator 250, rotary embedders 260A and 260B, and SiLU activator 270. These operators are arranged in a sequence as shown in FIG. 2. The sequence may indicate a timing sequence of the operators during the inference process. For the purpose of illustration, RMS normalizer is shown as “RMS norm” in FIG. 2, MatMul operator is shown as “MatMul” in FIG. 2, SoftMax activator is shown as “SoftMax” in FIG. 2, add operator is shown as “add” in FIG. 2, and product operator is shown as “product” in FIG. 2. In other embodiments, the DNN model 200 may include fewer, more, or different components. Also, the arrangement of the components in the DNN model 200 may be different.

The RMS normalizer 210A can standardize input data, such as input embeddings. The RMS normalizer 210A may perform an RMS normalization on an input to the DNN model 200 using a weight vector 201. In an example, the spatial size of the weight vector 201 may be 4, meaning the weight vector 201 includes 4 data elements in it. The RMS normalization may be denoted as

$$y = \frac{{x}_{i} \cdot {W}_{{RMS}_{i}}}{\sqrt{\frac{{\sum }_{j = 0}^{4 , 096} {x}_{j}^{2}}{4 , 096} + {10}^{- 5}}} ,$$

where i and j are indices, x is the input, W_{RMS} is the weight (which may be referred to as RMS attention weights), and y is the output. The weight vector 201 may also denoted as Wₙ₁. The RMS normalization can normalize input data elements of the DNN model 200 based on the RMS of the activations. The normalization may stabilize the inputs and ensure that the attention weights can be computed on approximately scaled inputs, leading to better training stability and faster convergence. The output of the RMS normalizer 210A may be one or more tokens. In an example, the token may be represented by a 15-bit integer. The output of the RMS normalizer 210A is a vector. In an example, the dimension of the vector is 4.

At least some of the MatMul operators 220A-220F can handle the transformation and integration of embedding vectors across different layers. As shown in FIG. 2, the output of the RMS normalizer 210A is provided to the MatMul operator 220A. The MatMul operator 220A performs MatMul on the output of the RMS normalizer 210A and a weight matrix 202. The weight matrix 202 may be a matrix of query weights, which may be denoted as W_{Q}. The MatMul result is provided to the MatMul operator 220B. The output of the RMS normalizer 210A is also provided to the MatMul operator 220B. The MatMul operator 220B performs MatMul on the output of the RMS normalizer 210A and a weight matrix 203. The weight matrix 203 may be a matrix of key weights, which may be denoted as W_{K}. The output of the RMS normalizer 210A is also provided to the MatMul operator 220C. The MatMul operator 220C performs MatMul on the output of the RMS normalizer 210A and a weight matrix 204. The weight matrix 204 may be a matrix of value weights, which may be denoted as W_{V}. The MatMul result of the MatMul operator 220A, MatMul operator 220B, or MatMul operator 220C may be a vector. In an example, the spatial size of the weight matrix 202, weight matrix 203, or weight matrix 204 is 4×4; and the dimension of the vector computed by the MatMul operator 220A, MatMul operator 220B, or MatMul operator 220C is 4.

The MatMul result computed by the MatMul operator 220A is provided to the rotary embedder 260A. The rotary embedder 260A may apply a weight matrix 205 on input data. The weight matrix 205 is represented by W_{R} in FIG. 2. The rotary embedder 260A may produce rotary positional encoded embeddings. In some embodiments, the operation of the rotary embedder 260A may be:

$$f ( {x}_{i} ) = {x}_{i} \cdot {w}_{r} - {x}_{i + 1} \cdot {w}_{i} , and$$

$$f ( {x}_{i + 1} ) = {x}_{i} \cdot {w}_{i} + {x}_{i + 1} \cdot {w}_{r} .$$

where x is the input to the MatMul operator 220A, and w is weight. In an example, the dimension of the weight matrix 205 is 128×512.

The MatMul result computed by the MatMul operator 220B is provided to the rotary embedder 260B. The rotary embedder 260B may apply a weight matrix 206 on input data. The weight matrix 206 is represented by W_{R} in FIG. 2. The rotary embedder 260B may produce rotary positional encoded embeddings. In some embodiments, the operation of the rotary embedder 260B may be:

$$f ( {x}_{i} ) = {x}_{i} \cdot {w}_{r} - {x}_{i + 1} \cdot {w}_{i} , and$$

$$f ( {x}_{i + 1} ) = {x}_{i} \cdot {w}_{i} + {x}_{i + 1} \cdot {w}_{r} .$$

where x is the input to the MatMul operator 220B, and w is weight. In an example, the dimension of the weight matrix 206 is 128×512.

The output of the rotary embedder 260A or rotary embedder 260B may be a vector. In an example, the dimension of the vector is 4. The output of the rotary embedder 260A is provided to the MatMul operator 220D. The MatMul operator 220D also receives keys from a KV cache 207. The cache 207 receives keys from the rotary embedder 260B. the MatMul operator 220D may perform a MatMul operation on the keys and the output of the rotary embedder 260A to compute a vector. In an example, the keys may be in a matrix, e.g., a matrix with a dimension of 2×<1024, in which <1024 may be a timestamp dimension T; the data received from the rotary embedder 260A may be a vector with a dimension of 2; and the output of the MatMul operator 220D may be a vector with a dimension of <1024.

The output of the MatMul operator 220D is provided to the SoftMax activator 230. The SoftMax activator 230 may apply a SoftMax function on the output of the MatMul operator 220D. The SoftMax function may be denoted as

$$\frac{{e}^{\frac{{x}_{i} - {x}_{max}}{\sqrt{64}}}}{{\sum }_{j = 0}^{t} {e}^{\frac{{x}_{j} - {x}_{max}}{\sqrt{64}}}} .$$

In an example, the output of the SoftMax activator 230 may be a vector with a dimension of <1024.

The output of the SoftMax activator 230 is provided to the MatMul operator 220E. The MatMul operator 220E also receives values from the cache 207. In some embodiments, at least some of the values are computed by the rotary embedder 260B. In an example, the values may be in a matrix, e.g., a matrix with a dimension of <1024×2, in which <1024 may be a timestamp dimension T; and the output of the MatMul operator 220E may be a vector with a dimension of 2. In some embodiments, T=1 for the first token. The context size may be denoted as Max T. In some embodiments, the MatMul operator 220D, SoftMax activator 230, and MatMul operator 220E may constitute a multi-headed attention block 214. In some embodiments, the DNN model 200 may include a plurality of multi-headed attention blocks 214 that can run in parallel. For instance, two embedding vectors may be split to two heads sized 2. The multi-headed attention block 214 may be a multi-headed attention layer.

The output of the MatMul operator 220E is input into the MatMul operator 220F. The MatMul operator 220F also receives a weight matrix 208. The weight matrix 208 is shown as Wₒ in FIG. 2. In an example, the dimensions of the weight matrix 208 is 4×4. The data received by the MatMul operator 220F from the MatMul operator 220E may be a vector, whose dimension may be 4. The output of the MatMul operator 220F may be a vector, whose dimension may be 4.

The output of the MatMul operator 220F is provided to the add operator 240A. The operators 240A may perform an elementwise addition on the output of the MatMul operator 220F and the input to the RMS normalizer 210. In some embodiments, the elementwise addition is denoted as ƒ(x, y)=x+y. In an example, the two inputs to the operators 240A may each be a vector with a dimension of 4, and the output of the operators 240B may also be a vector with a dimension of 4.

The output of the operators 240A is provided to the RMS normalizer 210B. The RMS normalizer 210B can standardize data it receives. The RMS normalizer 210B may perform an RMS normalization on the output of the operators 240A using a weight vector 209. In an example, the spatial size of the weight vector 201 may be 4. The RMS normalization may be denoted as

$$y = \frac{{x}_{i} \cdot {W}_{{RMS}_{i}}}{\sqrt{\frac{{\sum }_{j = 0}^{4 , 096} {x}_{j}^{2}}{4 , 096} + {10}^{- 5}}} ,$$

where i and j are indices, x is the input, W_{RMS} is the weight (which may be referred to as RMS attention weights), and y is the output. The weight vector 209 may also denoted as Wₙ₂. The RMS normalization can normalize data elements based on the RMS of the data elements. The normalization may stabilize the inputs and ensure that the attention weights can be computed on approximately scaled inputs, leading to better training stability and faster convergence. The output of the RMS normalizer 210B may be one or more tokens. In an example, the token may be represented by a 15-bit integer. In some embodiments, the output of the RMS normalizer 210B is a vector. In an example, the dimension of the vector is 4.

The output of the RMS normalizer 210B is provided to the MatMul operator 220G. The MatMul operator 220G also receives a weight matrix 211. The weight matrix 211 is shown as W₁ in FIG. 2. In an embodiment, the spatial shape of the weight matrix 211 is 4×10, the dimension of the output of the RMS normalizer 210B is 4, and the dimension of the output of the 220G is 10. The output of the MatMul operator 220G is provided to the SiLU activator 270. The SiLU activator 270 may apply a SiLU function on the output of the MatMul operator 220G. The SiLU activator 270 may perform the SiLU operation in an elementwise manner, meaning for every data element input into the SiLU activator 270, the SiLU activator 270 applies the SiLU function and computes an output data element. In an example, the input to the SiLU activator 270 is a vector including 10 data elements, and the output of the SiLU activator 270 is also a vector including 10 data elements.

The output of the RMS normalizer 210B is also provided to the MatMul operator 220H. The MatMul operator 220H also receives a weight matrix 212. The weight matrix 212 is shown as W₃ in FIG. 2. In an embodiment, the spatial shape of the weight matrix 212 is 4×10, the dimension of the output of the RMS normalizer 210B is 4, and the dimension of the output of the 220H is 10.

The output of the MatMul operator 220H is provided to the product operator 250. The product operator 250 also receives the output of the SiLU activator 270. The product operator 250 may perform an elementwise multiplication on the two inputs. The elementwise multiplication may be denoted as ƒ(x, y)=x·y. In some embodiments, the two inputs are each a vector including 10 data elements, and the output of the product operator 250 is also a vector including 10 data elements.

The output of the product operator 250 is provided to the MatMul operator 220I. The MatMul operator 220I also receives a weight matrix 213. The weight matrix 213 is shown as W₂ in FIG. 2. In an embodiment, the spatial shape of the weight matrix 213 is 10×4, the dimension of the output of the product operator 250 is 10, and the dimension of the output of the 220I is 4. In some embodiments, the MatMul operator 220G, 220H, product operator 250, and MatMul operator 220I may constitute a feed forward neural network 215. The 215 may be denoted as W₂(Silu(W₁(x))× W₃(x)). The feed forward neural network 215 can ensure rapid and effective data processing.

The output of the MatMul operator 220I is provided to the add operator 240B. the operators 240B also receives the output of the operators 240A. The operators 240B may perform an elementwise addition on the two inputs. The elementwise addition may be denoted as ƒ(x,y)=x+y. In an example, the two inputs are each a vector including 4 data elements, and the output of the operators 240B is also a vector including 4 data elements. The output of the operators 240B may be an output of the DNN model 200.

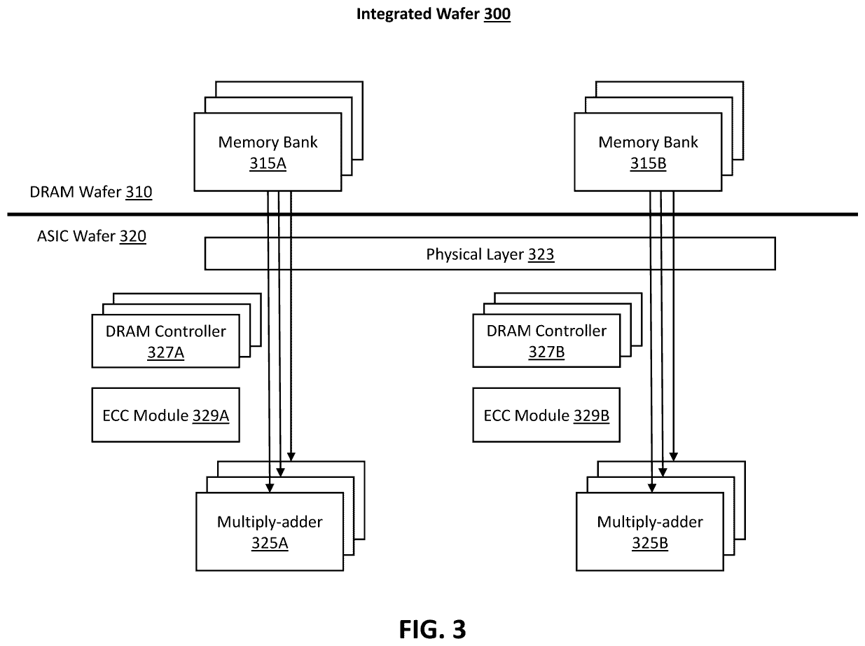

FIG. 3 illustrates an integrated memory-compute system 300, in accordance with various embodiments. The integrated memory-compute system 300 may implement DNNs, including LLMs. The integrated memory-compute system 300 may be designed to enhance the processing efficiency of DNNs. The integrated memory-compute system 300 may be an example of the IC device 100 in FIG. 1. As shown in FIG. 3, the integrated memory-compute system 300 includes a DRAM wafer 310 and an application-specific integrated circuit (ASIC) wafer 320. The DRAM wafer 310 may be placed on top of the ASIC wafer 320. The DRAM wafer 310 may be an example of a memory layer. The ASIC wafer 320 may be an example of a logic layer. The integrated memory-compute system 300 may be an integrated wafer or stacked wafer. In other embodiments, the integrated memory-compute system 300 may include multiple DRAM wafer 310 or ASIC wafer 320. The integrated memory-compute system 300 may also include components not shown in FIG. 3. For instance, the integrated memory-compute system 300 may include interconnects between the DRAM wafer 310 and ASIC wafer 320.

The DRAM wafer 310 includes memory banks 315A (individually referred to as “memory bank 315A”) and memory banks 315B (individually referred to as “memory bank 315B”), which are two memory bank groups. For the purpose of illustration, each memory bank group has three memory banks. In other examples, a memory bank group may include fewer or more memory banks. The memory banks 315A and memory banks 315B may be storage units where model weights or activation vectors are stored. The dual memory bank groups can ensure high bandwidth and parallel access to data.

The ASIC wafer 320 may be located directly below the DRAM wafer 310. The ASIC wafer 320 includes a physical layer 323, multiply-adders 325A (individually referred to as “multiply-adder 325A”), multiply-adders 325B (individually referred to as “multiply-adder 325B”), DRAM controllers 327A (individually referred to as “DRAM controller 327A”), DRAM controllers 327B (individually referred to as “DRAM controller 327B”), ECC module 329A, and ECC module 329B. In other embodiments, the ASIC wafer 320 may include fewer, more, or different components. The physical layer 323 may function as an interface connecting the DRAM wafer 310 and the ASIC wafer 320. The physical layer 323 may facilitate physical data transfer between the DRAM wafer 310 and ASIC wafer 320, such as data transfer between the memory banks 315A (or memory banks 315B) and the multiply-adders 325A (or multiply-adders 325B). In an example, the physical layer 323 is a Peripheral Component Interconnect Express (PCIe) physical layer. The physical layer 323 can ensure reliable, high-speed communication. In some embodiments, the DRAM wafer 310 and ASIC wafer 320 may constitute a plurality of integrated cells, each of which may include a memory bank with ECC logic for storing weights and a multiply-adder for performing DNN computations using the weights.

The multiply-adders 325A and multiply-adders 325B may be specialized computational units that perform multiply-add operations, which are fundamental for neural network computations, such as MatMul operations. The multiply-adders 325A and multiply-adders 325B may process the data fetched from the memory banks 315A and memory banks 315B, respectively, and execute the core arithmetic functions required by the DNN model. For instance, each of the multiply-adders 325A may receive data (e.g., weights or activations) from one of the memory banks 315A and perform multiply-accumulate operations on the data. Similarly, each of the multiply-adders 325B may receive data (e.g., weights or activations) from one of the memory banks 315B and perform multiply-accumulate operations on the data. In some embodiments, each of the memory banks 315A and the corresponding one of the multiply-adders 325A may form an integrated cell. Similarly, each of the memory banks 315B and the corresponding one of the multiply-adders 325B may form an integrated cell. The ASIC wafer 320 may have an array of integrated cells. In the example of FIG. 3, the array may have three rows and two columns. In other examples, the array may have a different number of rows or columns.

The DRAM controllers 327A and DRAM controllers 327B may manage communications to or from the memory banks 315A and memory banks 315B, respectively. For instance, the DRAM controllers 327A and DRAM controllers 327B may manage read and write operations associated with the memory banks 315A and memory banks 315B, respectively. The DRAM controllers 327A and DRAM controllers 327B can optimize data flow and maintain data integrity. In some embodiments, the DRAM controllers 327A and DRAM controllers 327B may manage read and write operations based on instructions from a flow control unit, e.g., the flow control unit 111 in FIG. 1. In some embodiments, each DRAM controller 327A may correspond to a particular memory bank 315A and a particular multiply-adder 325A. The DRAM controller 327A may manage data read and write between the corresponding memory bank 315A and multiply-adder 325A. The DRAM controller 327A may be part of the integrated cell that includes the memory bank 315A and multiply-adder 325A. The total number of DRAM controllers 327A in the ASIC wafer 320 may be the same as the total number of memory banks 315A in the DRAM wafer 310 or the total number of multiply-adders 325A in the ASIC wafer 320. Similarly, each DRAM controller 327B may correspond to a particular memory bank 315B and a particular multiply-adder 325B. The DRAM controller 327B may manage data read and write between the corresponding memory bank 315B and multiply-adder 325B. The DRAM controller 327B may be part of the integrated cell that includes the memory bank 315B and multiply-adder 325B. The total number of DRAM controllers 327B in the ASIC wafer 320 may be the same as the total number of memory banks 315B in the DRAM wafer 310 or the total number of multiply-adders 325B in the ASIC wafer 320.

The ECC module 329A and ECC module 329B (collectively referred to as “ECC modules 329” or “ECC module 329”) may be ECC circuitry that can detect and correct single-bit errors associated with communications to or from the memory banks 315A and memory banks 315B, respectively. The ECC module 329A may be located directly under the memory banks 315A. The ECC module 329B may be located directly under the memory banks 315B. Even though FIG. 3 shows a single ECC module for each memory bank group, there may be multiple ECC modules for a single memory bank group. For instance, the ASIC wafer 320 may include a different or separate ECC module for every memory bank in the DRAM wafer 310. The ECC module may be part of the integrated cell that includes the memory bank.

In some embodiments, the ECC modules 329 can provide built-in ECC checking and correction flow rather than relying on an external or separate ECC engine. The ECC modules 329 can provide integrated Single Error Correction and Double Error Detection (SECDED) logic near-memory arrays and facilitate time-domain ECC and output pipeline-based Hamming codes. There may be minimal, localized routing between the DRAM banks 315 and the ECC modules 329. In some embodiments, an ECC module 329 may be a pipeline-style ECC block. For instance, the ECC module 329 may facilitate a predetermined number of stages, e.g., 72 stages. The ECC module 329 may directly feed data between memory bank and multiplier-adder stages. The ECC module 329 may have a shift-register-based ECC design.

The ECC modules 329 may detect and correct single-bit errors in data read from the memory banks 315A and memory banks 315B. When reading extensive amounts of DRAM data (e.g., 5 GB or more) for each token inference, even a relatively small single-bit error rate can accumulate across multiple tokens, degrading the overall model accuracy. The ECC modules 329 can mitigate this and maintain a memory system immune to single-bit errors so that the data read from memory banks 315A and memory banks 315B can be the same as the data that had been written to the memory banks 315A and memory banks 315B. In some embodiments, an ECC module 329 may add extra bits to data, creating redundant information for detecting and correcting errors. For instance, the ECC module 329 may add extra 7 bits for every 64 bits of data. The extra bits may be parity bits. The ECC module 329 may use the extra bits to identify and fix errors that standard memory banks cannot. The extra bits may allow the ECC module 329 to check for bit flips, e.g., where a 0 becomes a 1 or vice versa, caused by electrical inference, radiation, or other issues. The ECC module 329 can then correct single-bit errors, preventing data corruption and system instability.

In some embodiments, an ECC module 329 may include a pipeline-based (e.g., 72-cycle) shift register that can be used for SECDED. When a single-bit error occurs, the ECC module 329 may identify and fix it. For instance, the ECC module 329 can fix the single-bit error by flipping the bit. When a double-bit errors. The ECC module 329 may detect it but may not correct it, preventing incorrect data from being used. The ECC module 329 may apply Hamming-based ECC in a time domain pipeline manner and provide time-domain Hamming codes for SECDED.

As data is read from memory and temporarily latched for processing, the ECC module 329 can detect and correct single-bit errors on the fly before the data is written back. This can ensure reliable long-running operation, preventing the compounding of errors for multi-token inferences across large datasets or extended inference sessions. By placing the ECC hardware near DRAM banks, each read operation can be corrected immediately, ensuring data integrity before any errors propagate through subsequent computations.

The integrated memory-compute system 300 can implement an ECC-enabled embedding architecture for reliable near-memory processing on silicon. Memory, multiply-add logic, and ECC logic can be closely co-located. Unlike currently available designs with extensive routing between separate memory and compute blocks, this architecture can embed both the ECC pipeline and computational elements directly next to the RAM, dramatically reducing data movement and saving on layout space. It can also eliminate the need to load external multiplication code. As data streams in from DRAM bank, ECC hardware may generate or check ECC bits in real time, detecting and correcting single-bit errors and flagging double-bit errors. Meanwhile, the multiply-add logic can use the retrieved data for high-throughput computations (e.g., vector or matrix multiplication). By stacking DRAM over the ASIC, the system can shorten the electrical paths, boosting bandwidth and efficiency while still preserving data reliability through ECC. The arrows in FIG. 3 represent that large numbers of parallel data/address lines can travel between the memory banks and the ASIC below.

The architecture of the integrated memory-compute system 300 can overcome reliability challenges caused by storing and accessing very large model weights, which are particularly prone to single-bit errors occurring in large-scale DRAM. Currently available designs typically encounter a growing accumulation of bit errors with each read-write cycle, significantly affecting accuracy in high-performance applications like LLMs. This architecture employs a vertically integrated DRAM die bonded on top of a logic die. The model's weights-often on the order of several gigabytes-can reside in the memory die, while the transformers and associated processing logic for DNNs can be placed in the logic die beneath. By situating memory directly above compute resources, data transfer distances are minimized, thereby reducing latency and power consumption. Crucially, each micro-bank of DRAM is coupled to a dedicated vector multiply-add unit, enabling parallel, near-memory computations every clock cycle. The conceptual design for this specialized LLM-processing chip comprises a memory die stacked directly atop a logic die. The top memory die stores the model's weights in DRAM banks sized to match the logical partitioning of matrix operations. The bottom logic die hosts the transformer architecture, controlling data flow and computations needed for LLM inference.

The multiply-add partitioning scheme can directly tie each micro-bank of DRAM to a dedicated compute unit, forming the backbone of the model's parallel capabilities. Every micro-bank can contain a carefully sized slice of the model's weight parameters. In some implementations, the scope of each bank may be limited to roughly one million parameters (or another optimal size) to reduce contention for memory access and allow for straightforward ECC management. After (e.g., once) data is read from a particular micro-bank, single-bit errors can be corrected on the fly before multiplication and accumulation. This parallel organization means that larger portions of the model can be processed simultaneously, significantly accelerating inference steps while preserving data accuracy.

This DRAM-based near-memory computing architecture can not only reduce data movement but also ensure integrity and reliability through streamlined ECC integration. Currently available designs often suffer from a buildup of memory errors when performing repeated read-write operations, especially in the prolonged and large-scale workloads typical of transformer inference. By embedding an ECC solution into each memory bank, the design can automatically capture and correct single-bit faults before any inaccuracies can propagate through downstream calculations. The architecture of the integrated memory-compute system 300 can not only minimize data transfer latency, significantly improving computational speed and energy efficiency, but also facilitate effective heat removal, enhancing the chip's overall thermal management. In some embodiments, power supply may be designed to come from the bottom, allowing for the support of larger models and easier scaling. Such a design can be particularly beneficial for applications requiring real-time processing and high-performance AI capabilities, making it an ideal solution for industries ranging from healthcare and finance to autonomous systems and advanced machine learning tasks.

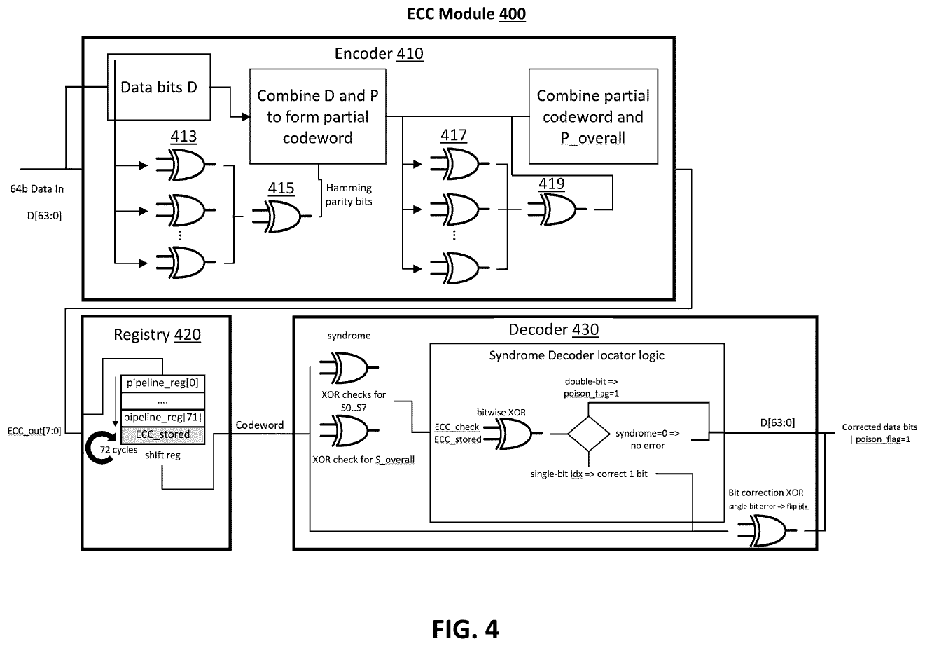

FIG. 4 illustrates an ECC module 400, in accordance with various embodiments. The ECC module 400 can apply harming-based ECC in a time domain pipeline manner. The ECC module 400 may be integrated into a cell that includes a memory bank and a compute unit for detecting or correcting errors associated with data transfer between the memory bank and compute unit. The ECC module 400 may be an example of the ECC modules 329 in FIG. 3. As shown in FIG. 4, the ECC module 400 includes an encoder 410, registry 420, and decoder 430. In other embodiments, the ECC module 400 may include fewer, more, or different components. For illustration, FIG. 4 shows how a time-domain Hamming code for SECDED is generated, stored, and then checked and corrected for a 64-bit data stream. The illustrated example implements 64 bits with 72 cycles. The ECC module 400 can support different designs, e.g., data stream of more or fewer bits, a different number of cycles, etc.

The encoder 410 includes two sets of XOR gates for generating ECC bits from data, such as data stored in the memory bank associated with the ECC module 400. An XOR (Exclusive OR) gate may be a digital logic gate that outputs true when an odd number of its inputs are true, meaning its output is 1 when inputs are different (0,1 or 1,0) while its output is 0 when inputs are the same (0,0 or 1,1). The first set of XOR gates of the encoder 410 include XOR gates 413 (individually referred to as “XOR gate 413”) and an XOR gate 415. The second set of XOR gates include XOR gates 417 (individually referred to as “XOR gate 417”) and an XOR gate 419. The first set of XOR gates can generate Hamming parity bits from data. The second set of XOR gates can generate an additional parity bit. In the illustrated example, 64 data bits (D [63:0]) enter the XOR gates 413, which provide their outputs to the XOR gate 415. The XOR gate 415 may perform an XOR operation on the outputs of the XOR gates 413 and generate Hamming parity bits (P0:P7). The 7 Hamming parity bits are combined with the 64 data bits to form a partial codeword of 71 bits. The partial codeword enters the XOR gates 417, which provide their outputs to the XOR gate 419. The XOR gate 415 may perform an XOR operation on the outputs of the XOR gates 417 and generate an additional overall parity bit (P overall). The additional overall parity bit can be used to detect double-bit errors. The additional overall parity bit is combined with the partial codeword to form a codeword of 72 bits. The codeword may be a data unit formed by combining original data with redundancy bits. The codeword (“ECC codeword”) include 64 data bits and 8 parity bits (“ECC bits”) appended to the data bits.

In some embodiments, the encoder 410 may generate the ECC codeword when data is written into the memory bank. After the ECC codeword is generated, it may be written into the memory bank. When data is read (e.g., when data is read from the memory bank by the compute unit), the ECC codeword may go through the registry 420 and decoder 430 for error detection or correction.

The registry 420 may be a shift register. The shift register may include a synchronous digital circuit using cascaded flip-flops to store and shift binary data (bits) left or right. In the illustrated example, the registry 420 is a 72-cycle shift register that can facilitate a 72-cycle pipeline. The newly formed 72-bit codeword can be pushed through the 72-cycle shift register (or pipeline). With this “time domain” approach, each bit can travel down the shift register till, after 72 clock cycles, the entire codeword arrives at the decoder stage.

The decoder 430 receives the codeword from the registry 420 after (e.g., once) the data bits plus ECC bits exit the pipeline. The decoder 430 may recompute parity from the 64 data bits (ECC_check) and bitwise compares it to the stored ECC bits (ECC_stored), yielding an 8-bit syndrome (S0 through S7). The decoder 430 may detect errors based on the syndrome. For instance, when the syndrome is 0, the decoder 430 detects no error; otherwise, it designates a single-bit error. When a single-bit error is detected, the decoder 430 may identify the specific bit location and flip the bit to correct the error. When the overall parity also indicates a mismatch, the decoder 430 detects a second error and raises a “poison_flag” to mark the data as uncorrectable. The data can be either emerged corrected or flagged as poisoned when a double-bit error is detected.

By shifting data through the 72-cycle pipeline, the ECC module 400 can ensure that each packet of data has its ECC generated at the front end (e.g., in the encoder 410) and verified at the back end (e.g., in the decoder 430), providing real-time single-bit error correction and double-bit error detection.

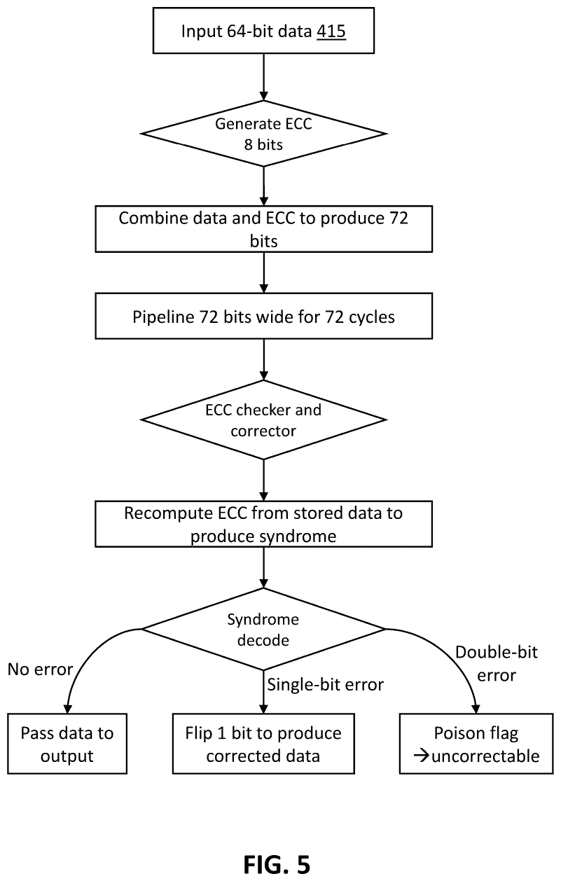

FIG. 5 illustrates an ECC flow, in accordance with various embodiments. The ECC flow may be a flow within an ECC module, e.g., the ECC modules 329 in FIG. 3 or ECC module 400 in FIG. 4. In the illustrated ECC implementation, 64-bit data is input into the ECC module. The 64-bit data may be one or more weights or activations of a DNN. 8 ECC bits are generated from the 64-bit data. Then the data and ECC bits are combined to produce 72 bits. The 72 bits are then fed into a pipeline that is 72 cycles deep. Effectively, each bit can move through one stage of the pipeline per clock cycle, and after 72 cycles the entire word emerges at the output for ECC checker and corrector. At that point, the ECC module may recompute the ECC across the 64 data bits, compare it with the stored ECC bits, and produce a syndrome. When no error is found, the data may pass the ECC module without any change. The data may be input into a multiply-adder for computation. When the ECC module detects a single-bit error, the ECC module may correct it. The corrected data may be input into a multiply-adder for computation. When the ECC module detects a double-bit error, the ECC module may raise an uncorrectable error flag. The data may not be input into any multiply-adder, and computation on the data may be skipped. This time-domain approach can ensure that during the data's transit through the pipeline, any transient or single-bit fault can be identified and corrected at the end of those 72 cycles, preserving data integrity.

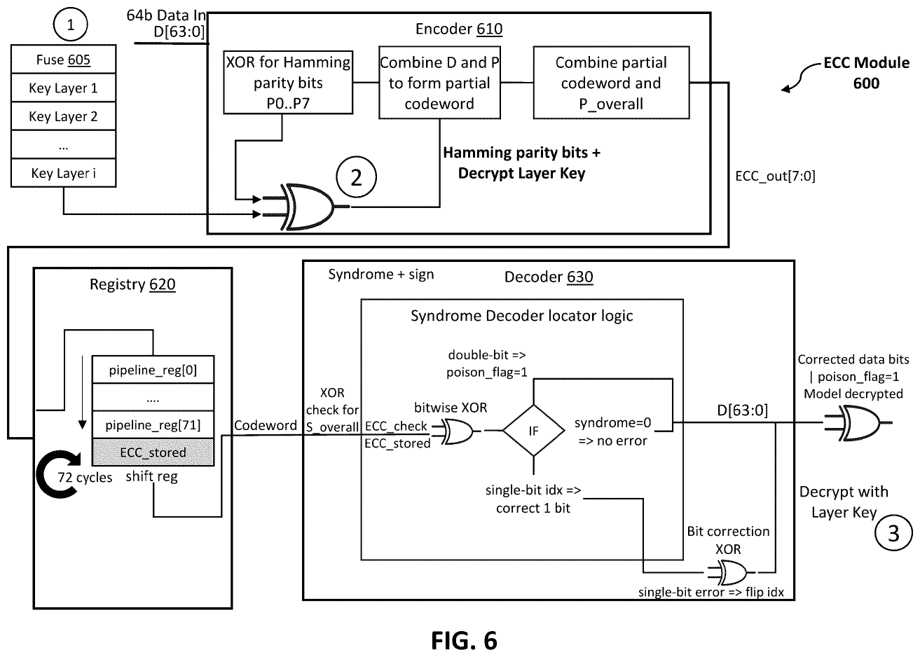

FIG. 6 illustrates an ECC module 600 capable of data decryption, in accordance with various embodiments. The ECC module 600 can detect or correct errors in data read or write operations. The ECC module 600 can also facilitate data security through layer key decryption of encrypted data, such as encrypted weights or tokens. In some embodiments, the ECC module 600 may be integrated into a cell that includes a memory bank and a compute unit for detecting or correcting errors associated with data transfer between the memory bank and compute unit. The ECC module 600 can also provide a secure mechanism to protect high-value data (such as neural-network weights or tokens) in memory by integrating an encryption engine with ECC. The ECC module 600 may reside in a system for DNN inference, such as a system including a 3D integrated wafer that implements transformer inference. The ECC module 600 may be an example of the ECC modules 329 in FIG. 3. The ECC module 600 includes an encoder 610, registry 620, and decoder 630. In other embodiments, the ECC module 600 may include fewer, more, or different components.

The encoder 610 may generate ECC codewords from input data. An ECC codeword may be a data unit formed by combining original data with extra parity bits. The input data may be weights or tokens. The registry 620 may also incorporate layer key decryption. In the illustrated example, the encoder 610 receives a 64-bit data input (D[63:0]) and layer decryption keys. The 64-bit data may include one or more weights or tokens. The encoder 610 may compute Hamming parity bits (P0 through P7) from the 64-bit data input (D[63:0]) through a series of XOR operations. The encoder 610 may then combine the 64-bit data and 8 parity bits to form a partial code word. An additional parity check (P_overall) may then be appended to the partial code word to form the complete ECC-protected word.

In some embodiments, before storing the data or ECC codeword in memory, the encoder 610 may apply the appropriate layer decryption key to decrypt the ECC codword. This can ensure that even the ECC bits themselves are not written in plain text form. In the illustrated example, the encoder 610 receives one or more layer decryption keys from a fuse 605. The fuse 605 may be a hardware fuse. For instance, the fuse 605 may be a programmable storage unit in memory that can be embedded into the system. In some embodiments, the fuse 605 may be in the memory bank associated with the ECC module 600. In other embodiments, the fuse 605 may be outside the memory bank. There may be one or more other fuses in the memory layer. The fuse 605 can store a plurality of layer decryption keys, each of which may be specific to a particular layer of the DNN model. The layer decryption keys may be pre-generated by the system, e.g., during the process of encrypting the weights or tokens. The layer decryption keys may have been burnt into the 605 during manufacturing.

In case of a single-bit error, the stored ECC (ECC_stored) can allow the ECC module 600 to detect and correct that bit automatically, as depicted in the bottom right of FIG. 6. Meanwhile, when any unauthorized party attempts to read the data directly from memory, the data can remain encrypted and thus unusable without the fused key. For simplicity, FIG. 6 shows a single XOR gate in the encoder 610, but the encoder 610 may include multiple XOR gates.

The registry 620 may be a 72-cycle shift register that can facilitate a 72-cycle pipeline. In the illustrated example, the newly formed 72-bit codeword is pushed through the 72-cycle shift register (or pipeline). With this “time domain” approach, each bit can travel down the shift register till, after 72 clock cycles, the entire codeword arrives at the decoder stage.

The decoder 630 receives the codeword from the registry 620 after (e.g., once) the data bits plus ECC bits exit the pipeline. The decoder 630 may recompute parity from the 64 data bits (ECC_check) and bitwise compares it to the stored ECC bits (ECC_stored), yielding an 8-bit syndrome (S0 through S7). The decoder 630 may detect errors based on the syndrome. For instance, when the syndrome is 0, the decoder 630 detects no error; otherwise, it designates a single-bit error. When a single-bit error is detected, the decoder 630 may identify the specific bit location and flip the bit to correct the error. When the overall parity also indicates a mismatch, the decoder 630 detects a second error and raises a “poison_flag” to mark the data as uncorrectable. The data can be either emerged corrected or flagged as poisoned when a double-bit error is detected.

The ECC module 600 provides a data security mechanism that is different from and more advantageous to currently available technologies. Currently available memory-based systems typically store ECC data alongside plaintext payloads, creating security risks when attackers gain hardware access. Likewise, conventional encryption often introduces significant overhead when combined with error-correction. In contrast, the ECC module 600 can intertwine encryption keys into the ECC process. By encoding data, ECC bits, and the decryption key in one parallel pipeline, it can eliminate the need to store or handle plaintext data at rest. Data can be decrypted on read only to lower latency. Also, single-bit errors can be corrected to guarantee integrity. Furthermore, distributing the model across multiple dies, each with a portion of the encryption keys, can mitigate large-scale data theft and ensure secure, efficient computations.

In some embodiments, the ECC module 600 may be a logic block or module within the system's memory controller or processor chip. The ECC module 600 provides integrated ECC with cryptographic key management. It can facilitate on-the-fly encryption or moving target encryption. In some embodiments, the ECC module 600 (e.g., the encoder 610) may include an encryption engine (e.g., AES core or ECC controller) that can be physically integrated with the ECC circuitry for detecting or correcting errors. The ECC module 600 may include extra registers or debug interfaces. The ECC module 600 may use additional internal registers or status bits relating to cryptographic functions. The memory interface in the system may have additional lines or signals for key exchange or for coordinating secure ECC checks.

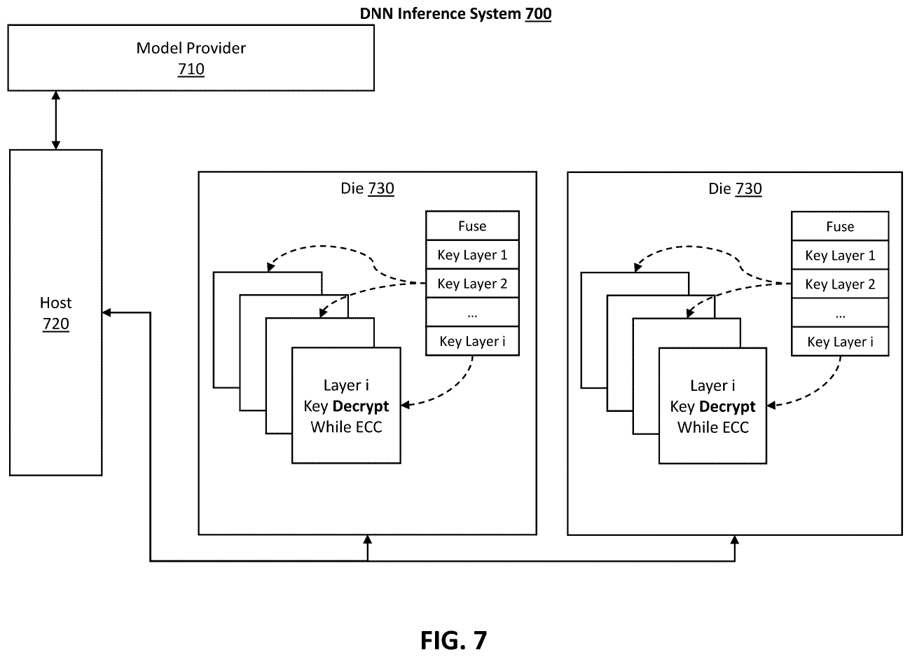

In some embodiments, the system may facilitate encryption of weights or tokens with O(1) decryption. Prior to loading neural-network weights or tokens into memory, the system may encrypt the weights or tokens using a key. The size of the key may correspond to the total number of weights or tokens. On each load, the encryption key may be refreshed creating a moving target that complicates any attempt to capture or replay the data. After (e.g., once) loaded, each weight or token can be decrypted on the fly with O(1) overhead, ensuring minimal performance impact during inference or computation. Certain aspects regarding encryption of weights or tokens are described below in conjunction with FIG. 7.

In modern AI applications, especially those involving large language models, model weights can scale up to or beyond one trillion parameters, making real-time encryption and decryption computationally challenging. Consequently, frontier labs and organizations typically confine these models to secure data centers because they lack reliable hardware-level mechanisms to verify licensed or paid usage on edge devices. Currently available solutions, such as simple encryption or software-based license checks, do not provide robust tamper-resistance or meaningful monetization controls, nor do they integrate with ECC to confirm that a model in memory is both correct and authorized. Currently available ECC do not include mechanisms to prevent unauthorized reading of the stored data.

FIG. 6 illustrates a combined hardware and cryptographic solution that can not only correct random memory errors but also enforce real-time authentication of the AI model. It can also verify paid or licensed usage. By embedding a verifiable key and secure checking mechanism into the ECC process itself, the system can both guarantee correct operation of the intended model on the edge and provide a pathway for monetization. In FIG. 6, the ECC module 600 is paired with encryption so that data is not at rest in plaintext. Both the ECC bits and the data can be protected, preserving data integrity and confidentiality. When the ECC module 600 detects a memory error, the ECC module 600 can correct the error on the encrypted data, thereby preventing attackers from using memory corruption or error injection as an attack vector.

In some embodiments, the memory block is hashed (e.g., using SHA-256 or SHA-512) to further ensure integrity. The hash function can output a fixed-size digest that uniquely identifies the memory block's contents. When a single bit differs, the digest can change. In some embodiments, the system can also generate and store cryptographic signature. After computing the hash, the system can sign the digest using a private key (e.g., Rivest-Shamir-Adleman (RSA) private key or Elliptic Curve Digital Signature Algorithm (ECDSA) private key). The resulting signature can be stored with or alongside the memory block, providing proof that the data originated from a trusted source and has not been tampered with. The system can also verify memory block integrity. In some embodiments, before use (e.g., when first loading or on demand), the system verifies the signature with the corresponding public key. When the verification fails, the system can determine that the hash or signature is invalid and reject the data load, preventing compromised or altered blocks from being used.

The ECC module 600 may be implemented at memory interface, e.g., as described above in conjunction with FIG. 3. The close coupling of memory and logic can reduce data movement for higher performance and energy efficiency. This reliability and efficiency can enable robust, high-performance solutions for advanced AI applications. The integrated, time-domain ECC design can be implemented in a chip or module by integration of time-domain ECC logic with closely co-located sequential RAM, multipliers, and adders (e.g., all within one cell or a small cluster of cells). As described above, there may be a pipeline-based (e.g., 72-cycle) shift register used for SECDED. Unlike currently available designs with extensive routing between separate memory and compute blocks, the architecture(s) disclosed herein may embed both the ECC pipeline and computational elements directly next to the RAM, dramatically reducing data movement and saving on layout space. In some implementations, RAM may be stacked on top of the compute layer, which can eliminate the need to load external multiplication code.

FIG. 7 illustrates a multi-die encryption scheme within a DNN inference system 700, in accordance with various embodiments. The DNN inference system 700 can implement secured DNN inference, including secured inference of transformer-based models. An example of the models is the DNN model 200 in FIG. 2. The DNN inference system 700 can perform layered model encryption or description across multiple dies. As shown in FIG. 7, the DNN inference system 700 includes a model provider 710, a host 720, and dies 730 (individually referred to as “die 730”). In other implementations, the multi-die encryption scheme may include fewer, more, or different components. For instance, the multi-die encryption scheme may include fewer or more dies. The DNN inference system 700 may be a system-on-a-chip.

The model provider 710 can prepare and encrypt DNN models, including large DNNs such as transformer-based large models. The model provider 710 may receive a pretrained DNN model and encrypt the model using the number of layer keys and the number of dies 730. In some embodiments, the model provider 710 may segment a DNN model into layers, e.g., Layer 1, Layer 2, and so on. The model provider 710 may encrypt each layer (e.g., weights or tokens of each layer) with a specific key. The specific key may be fused at manufacturing time into the dies 730. The encryption keys used for each layer can be burnt into the hardware fuses.

The host 720 may receive the encrypted model from the 710. The host 720 may also compile the encrypted model and generate commands for the dies 730, such as configuration parameters. The commands may be provided to a flow control unit implemented in the dies 730, e.g., the flow control unit 111 in FIG. 1. The host 720 may further load the encrypted model into the dies 730 for inference. In some embodiments, the host 720 may include one or more CPUs.

The dies 730 may be an IC device that embeds the encrypted model. An example of the IC device is the IC device 100 in FIG. 1. Each die 730 may be an integrated die including a memory die and a logic die. The memory dies may store data for secured DNN inference, such as encrypted weights or encrypted tokens. The memory die may be a DRAM. In an example, each die 730 may include a 5 GB DRAM. The logic die may include one or more DRAM controllers (e.g., the DRAM controllers 327A or DRAM controllers 327B in FIG. 3), ECC modules (e.g., the ECC modules 329 in FIG. 3 or ECC module 600 in FIG. 6), and multiply-adders (e.g., the multiply-adders 325A or multiply-adders 325B in FIG. 3). When the encrypted model is loaded from the host 720 into the dies 730, the corresponding layer key can be employed to decrypt data while ECC can be performed in parallel. By dividing the model into multiple layers, each die 730 can hold part or all the model layers (depending on capacity). This approach can enable secure distribution of large machine-learning models. This approach can ensure that only authorized systems with the correct fused keys can decrypt and run the model.

Each die 730 may be at least part of a multi-bank memory system with dedicated arithmetic units (e.g., multiply-adders) to accelerate vector operations and a mechanism for embedding decryption keys into the ECC encoding/decoding process, ensuring that data is never stored in plaintext. Layer-by-layer encryption keys can be fused into the die 730, allowing the model provider 710 to encrypt multiple layers across multiple memory dies for large-scale DNNs or similar computational workloads.

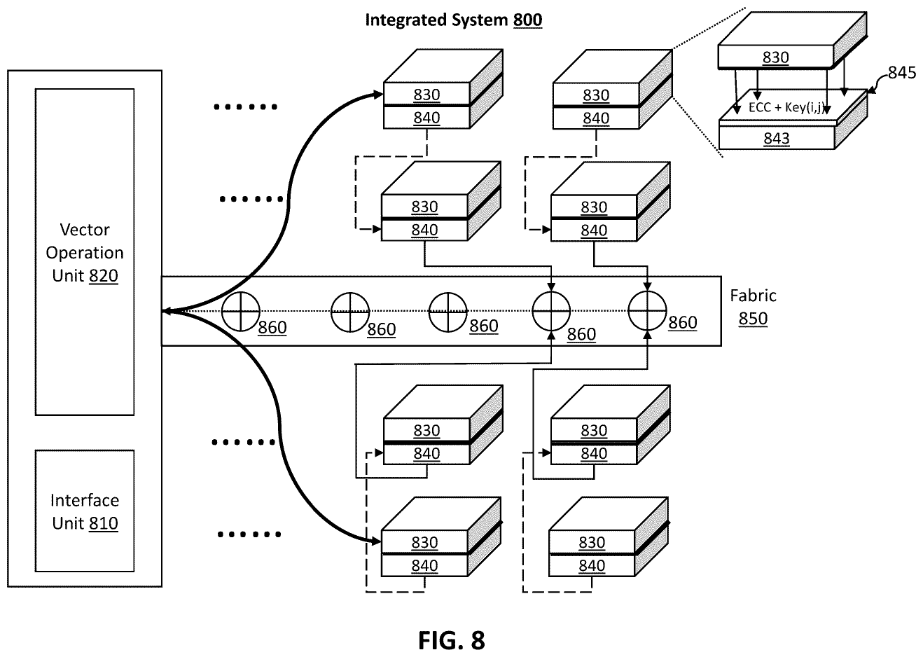

FIG. 8 illustrates an integrated system 800 with ECC-key integration, in accordance with various embodiments. The integrated system 800 may implement secured inference of a DNN model, such as the DNN model 200 in FIG. 2. The integrated system 800 may be an integrated die. The integrated system 800 may be an IC device, such as the IC device 100 in FIG. 1. The integrated system 800 may be a part of the DNN inference system 700 in FIG. 7. For instance, the integrated system 800 may be at least part of the dies 730 in FIG. 7. As shown in FIG. 8, the integrated system 800 includes an interface unit 810, a vector operation unit 820, memory blocks 830 (individually referred to as “memory block 830”), logic blocks 840 (individually referred to as “logic block 840”), fabric 850, and adders 860 (individually referred to as “adder 860”). In other embodiments, the integrated system 800 may include fewer, more, or different components. For instance, the integrated system 800 may include a different number of memory blocks 830, logic blocks 840, or adders 860. Also, the layout of the components may be different from the layout shown in FIG. 8.

The interface unit 810 may receive data from or send data to other devices or systems. For instance, the interface unit 810 may receive DNN inputs or send out DNN outputs. In some embodiments, the interface unit 810 may include a PCI interface, such as a PCIe unit. The interface unit 810 may provide received data to the vector operation unit 820 for initial processing. For instance, the interface unit 810 may provide a DNN input to the vector operation unit 820 for performing vector operations in the DNN. The DNN input may be an input prompt from a user. The input prompt may include one or more words, images, audio signals, other types of data, or some combinations thereof. The interface unit 810 may also send internal parameters of the DNN to the vector operation unit 820 or memory blocks 830. The internal parameters may have values determined by training the DNN.

The vector operation unit 820 may implement vector operations in DNNs. The vector operations may include embedding operation, rotary operation, activation function, RMS normalization, inverse operation, or other types of vector operation. In some embodiments, the vector operation unit 820 may include the tokenizer unit 112, embedder unit 113, RMS normalizer unit 114, rotary embedder unit 115, SiLU unit 116, SoftMax unit 117, or sampler unit 118 in FIG. 1. The vector operation unit 820 can accelerate the processing of DNNs, such as transformer models. In some embodiments, the vector operation unit 820 executes a wide range of mathematical operations on vectors, which can be essential for the various stages of model computation, including embedding and rotary transformations.

In some embodiments, the vector operation unit 820 includes one or more registers, such as vector register and scalar register. In an example, the vector operation unit 820 is equipped with four vector registers (V1, V2, V3, V4) and four scalar registers (S1, S2, S3, S4). The registers may store intermediate data or operands during computations. In some embodiments, the registers may store numbers of various formats. For instance, a register may hold BF16 numbers, where BF stands for bfloat. Additionally or alternatively, a register may hold FP4, FP8, FP16, FP32, or other types of floating-point numbers.

The vector operation unit 820 can perform complex calculations with high precision and efficiency. In some embodiments, the vector operation unit 820 supports an extensive set of instructions, including addition (ADD), multiplication (MUL), exponential functions (EXP), and vector-specific operations like finding maximum (MAX_V), minimum (MIN_V), and summation (SUM_V). Additionally, the vector operation unit 820 may incorporate look-up tables (LUTs) for quick access to precomputed values used in activation functions such as SiLU, GILU, and rectified linear unit (ReLU), as well as for RMS and inverse computations. For instance, one or more LUTs may store precomputed output values of an activation function. An LUT entry may specify an input value or a range of input values and specify the precomputed output value for the input value or the input value range. After the vector operation unit 820 receives an input value to the activation function, the vector operation unit 820 (or the LUT of the vector operation unit 820) may output the precomputed output value. In some embodiments, the precomputed values may be computed offline, e.g., before the execution of the DNN model starts.

The table below lists vector instructions of the vector operation unit 820, in accordance with various embodiments. The vector operation unit 820 may also feature masking options to selectively process elements and instructions for handling immediate values and addressing. By integrating these capabilities, the vector operation unit 820 can significantly enhance the computational throughput and efficiency of the integrated system 800, enabling real-time processing and scalable deployment of large-scale models.

Instructions:

| | |
|---|---|
| ADD | C = A + B |
| MUL | C = A * B |
| EXP | C = EXP(A) |
| MAX_V | C = MAX{A} |
| MIN_V | C = MIN{A} |
| SUM_V | C = SUM{A} |
| LUT_S | C = LUT{A}, LUT address B |
| LOAD | LOAD A to address B |
| STORE | STORE A in address B |
| RX | |
| TX | |

RMS micro-code (mask = 3072):

| | | |
|---|---|---|
| LOAD_V | Load (V3) | Load weights vector from memory |
| GET_V | Get(V1) | |
| MUL | V2 = V1*V1 | |
| SUM_V | S1 = Sumall(V2) | |
| LUT_S | S2 = LUTI(S1) | RMS formula: |
| | | 1/(sqrt(x/3096) + 10\hat{ }-5) |
| Set | S2 -> V4 | |
| MUL | V2 = V4*V1 | |
| MUL | V1 = V2*V3 | |
| SEND_V | Send(V1) | |

SoftMax micro-code (mask = pos):

| | | |
|---|---|---|
| ASSIGN_SI | S2 = Immediate | S2 = 1/sqrt(128) |
| GET_V | Get(V1) | |
| MAX_V | S1 = Max(V1) | |
| ADD_SV | V2 = S1 + V1 | with minus option |
| MUL_SV | V1 = S2 * V2 | |
| EXP_V | V2 = Exp (V1) | |
| SUMALL_V | S1 = Sum(V2) | |
| LUT_S | S2 = LUT2(S1) | inverse formula: 1/x |
| MUL_SV | V1 = S2 * V2 | |
| SEND_V | Send(V1) | |

Scaling micro-code (mask = 3072)

| | | |
|---|---|---|
| ASSIGN_SI | S4 = Immediate | |
| GET_V | Get(V1) | S4 = 1/256 |
| MAX_V | S1 = Max(V1) | |
| MIN_V | S2 = Min (V1) | |
| ADD_SS | S3 = S1 + S2 | |
| MUL_SS | S1 = S4*S3 | With minus on S2 |
| MUL_SV | V2 = S1 * V1 | |
| SEND_V | Send(V1) | |

In an example, the vector operation unit 820 may perform the following flow for an embedding operation:
LOAD V: Load the initial embedding vectors into the registers;
GET V: Retrieve the required vectors;
MUL: Multiply the vectors as needed;
EXP: Apply exponential functions using LUTs for activation functions like SiLU/GILU/ReLU;
SUM V: Sum the vector elements; and
SEND_V: Send the processed vectors to the next stage.

In an example, the vector operation unit 820 may perform the following flow for a rotary operation:
ASSIGN_SI: Assign an immediate value to a scalar register;
GET_V: Retrieve the vectors for rotary embeddings;
MAX_V: Find the maximum value in the vector;
ADD_SV: Add scalar and vector values;
SUMALL_V: Sum all vector elements;
LUT_S: Look-up table operations for further transformations; and
SEND_V: Send the final vectors for further processing or storage.

In some embodiments, data may be transferred between the vector operation unit 820 and memory blocks 830. For instance, data (e.g., vectors) may be loaded into registers of the vector operation unit 820 from the memory blocks 830, or vice versa. In some embodiments, loading a vector from memory to registers takes 512 cycles, which may utilize one memory bank of 256 bits. Data loading can be done in parallel with computation to avoid performance impacts.

The memory blocks 830 store data processed or generated by the logic blocks 840. The data may include data received by the interface unit 810, data computed by the vector operation unit 820, and data computed by the logic blocks 840. In some embodiments, the memory blocks 830 may constitute one or more memories, such as DRAM, SRAM, and so on. Each memory block 830 may be a memory bank, e.g., a DRAM bank. In some embodiments, the memory blocks 830 may have the same storage size, e.g., 1 MB. In some embodiments, data stored in the memory blocks 830 may be encrypted. For instance, the memory blocks 830 may store encrypted weights or encrypted tokens. In some embodiments, certain data (e.g., layer decryption keys) may be stored into the memory blocks 830 during manufacturing. The memory blocks 830 may include fuses where layer decryption keys are stored.

In the embodiments of FIG. 8, each memory block 830 corresponds to a logic block 840 and is communicatively coupled to the logic block 840. For instance, the memory block 830 is connected to the logic block 840 through a via. The via may be a through-silicon via (TSV). The memory block 830 may store data processed or generated by the logic block 840, and the data may be transferred between the memory block 830 and the logic block 840 through the via. Data stored in the memory blocks 830 can be quickly accessed by the logic blocks 840 due to the proximity of the memory blocks 830. The memory blocks 830 and logic blocks 840 can enable multi-bank vector operation and ECC-key integration.

The logic blocks 840 may perform vector operations in parallel. The memory blocks 830 may be connected to the PCI or another host interconnect through the fabric 850, which may be a high-bandwidth data bus. The curved arrows in FIG. 8 indicate how input data vectors can be split and fed into different ones of the memory blocks 830 for parallel computations. In some embodiments, each pair of a memory block 830 and logic block 840 can simultaneously carry out part of a DNN operation, e.g., a matrix multiplication for DNN inference.

Each logic block 840 may include a multiply-adder 843 and an ECC module 845. The multiply-adder 843 may perform computations in matrix multiplication operations of the DNN. Examples of the multiply-adder 843 include the multiply-add units 122 in FIG. 1, multiply-add units 132 in FIG. 1, multiply-adders 325A in FIG. 3, or multiply-adders 325B in FIG. 3. The ECC module 845 may perform error detection, error correction, or data decryption. Examples of the ECC module 845 include the ECC module 329 in FIG. 3, ECC module 400 in FIG. 4, and ECC module 600 in FIG. 6. In some embodiments, ECC data can be stored alongside corresponding layer keys in the memory block 830. In the illustrated example, the memory block 830 may store ECC data and key (i, j), where i may be the index of the layer and j may be the index of a data block of the layer. The ECC module 845 may use the ECC data to detect or correct errors and use the keys to decrypt data. For instance, the ECC module 845 may use the layer keys during data reads and writes so that any data leaving the memory blocks 830 can be automatically encrypted or decrypted in tandem with ECC generation or checking. By coupling ECC and decryption within the hardware pipeline, errors can be corrected on the fly, and decrypted data is instantly available in memory for further computations.

The fabric 850 allows the interface unit 810, vector operation unit 820, memory blocks 830, and logic block 840 to communicate with each other. In some embodiments, the fabric 850 may connect the interface unit 810, vector operation unit 820, memory blocks 830, and logic block 840. For instance, the fabric 850 may include a network of conductive pathways that connect the interface unit 810, vector operation unit 820, memory blocks 830, and logic block 840. The conductive pathways may include metal wires. The fabric 850 can provide high-bandwidth and low-latency connections. In some embodiments, the fabric 850 may build interconnect directly into the silicon wafer itself. The fabric 850 can enable high-density integration and efficient packaging.

The adders 860 are arranged on the fabric 850 as shown in FIG. 8. In some embodiments, the adders 860 may perform summations in matrix multiplication operations of the DNN. Outputs of the logic block 840 may be provided to the adders 860. The adders 860 may be arranged in a sequence. The first adder 860 may receive the outputs of two or more logic blocks 840 and compute a sum from the outputs of the two or more logic blocks 840. The second adder 860 may receive the output of the first adder 860 and compute a sum of the output of the first adder 860 and one or more other logic block 840. Similarly, the third adder 860 may receive the output of the second adder 860 and compute a sum of the output of the second adder 860 and one or more other logic block 840. This may continue till the last adder 860 computes an output data point (e.g., an output activation) of a matrix multiplication operation.

In some embodiments, the interface unit 810, vector operation unit 820, logic block 840, fabric 850, and adders 860 may be in a logic die, while the memory blocks 830 may be in a memory die. This 3D design may be achieved by wafer bonding a memory wafer (e.g., a DRAM wafer) on top of a logic wafer, or vice versa. After the wafers are diced, each chip stack may include a high-density memory on the top and specialized compute logic on the bottom (or vice versa), and the memory and compute logic may be connected by TSVs. The logic layer, which is equipped with the vector operation unit 820, logic block 840, and adders 860, may be capable of handling all transformer-related processing steps, including activation, normalization, rotary embedding, dynamic scaling, sampling, and so on.

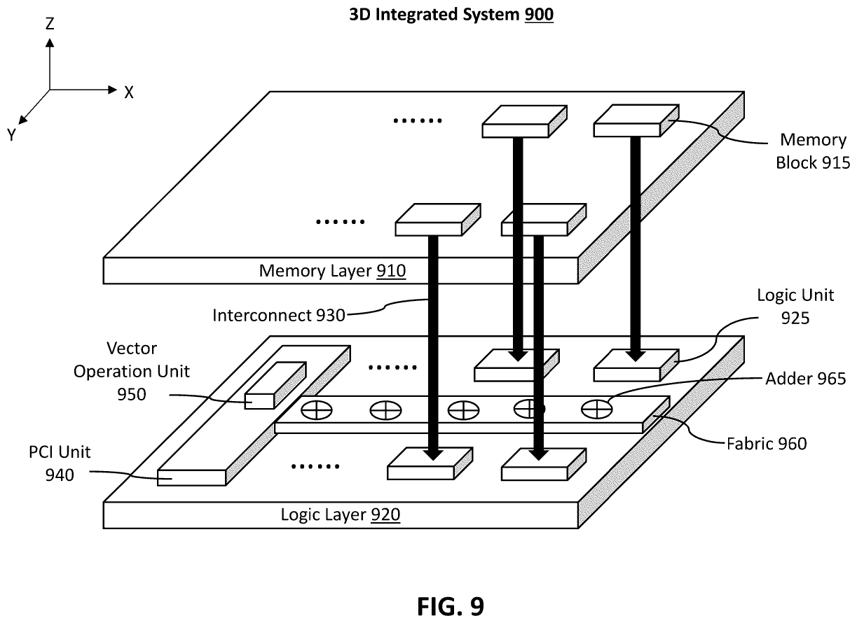

FIG. 9 illustrates a perspective view of a 3D integrated system 900, in accordance with various embodiments. The 3D integrated system 900 may implement at least part of a DNN model, such as a transformer model. The 3D integrated system 900 may be an example of the integrated system 800 in FIG. 8. As shown in FIG. 9, the 3D integrated system 900 includes a memory layer 910, a logic layer 920, and TSVs 930 (individually referred to as “TSV 930”). In other embodiments, the 3D integrated system 900 may include fewer, more, or different components. For instance, the 3D integrated system 900 may include one or more additional memory layers above the memory layer 910.

The memory layer 910 may be a memory, such as DRAM. The memory layer 910 includes memory blocks 915 (individually referred to as “memory block 915”). In an embodiment, each memory block 915 is a DRAM block. In another embodiment, each memory block 915 is a ROM block, such as a sequential ROM block. In yet another embodiment, the memory blocks 915 include one or more DRAM blocks and one or more ROM blocks. The memory layer 910 may be a memory wafer or memory die, such as the memory die 410 in FIG. 4. In some embodiments, the 3D integrated system 900 may include multiple memory dies.

The logic layer 920 includes logic units 925 (individually referred to as “logic unit 925”), PCI unit 940, vector operation unit 950, fabric 960, and adders 965. The logic units 925 may be examples of the logic blocks 840 in FIG. 8. Each logic unit 925 is connected to a different memory block 915 through a TSV 930. As shown in FIG. 9, the logic units 925 are arranged on two opposite sides of the fabric 960. The logic units 925 may be specialized compute units that can perform the complex mathematical operations required by transformer architecture. The logic layer 920 may be a logic wafer or logic die.

The PCI unit 940 facilitates external communications of the 3D integrated system 900. The PCI unit 940 may be an interface that connects the 3D integrated system 900 to one or more other devices, such as a computer's motherboard, CPU, GPU, etc. In some embodiments, the PCI unit 940 facilitates the PCI Express (PCIe) standard and use lanes to provide high data transfer speeds. The PCI unit 940 may act as a bus or data highway and allow the 3D integrated system 900 to communicate with a host, e.g., a CPU. The PCI unit 940 may receive data from the host for other components of the 3D integrated system 900 to process and send data computed by for other components of the 3D integrated system 900 to the host.

The vector operation unit 950 is a compute unit that can process data to perform vector operations in the DNN model. The data processed by the vector operation unit 950 may be received from the PCI unit 940. The vector operation unit 950 may include registers that can store the received data or data computed by the vector operation unit 950. The registers may include both vector registers and scalar registers. The vector operation unit 950 can perform various operations required by transformers in accordance with vector instructions. In an example, a vector instruction may define or specify one or more mathematical computations required by the DNN model. Such vector instructions may include ADD, MUL, EXP, MAX_V, MIN_V, SUM_V, LUT_S, and so on. In another example, a vector instruction may indicate data transferred required by the DNN model, e.g., retrieving data or sending data.

In the embodiments of FIG. 9, the vector operation unit 950 is arranged on the PCI unit 940. In other embodiments, the vector operation unit 950 may be arranged next to the PCI unit 940. In some embodiments, one or more other units may be arranged on the PCI unit 940. For example, a flow control unit may be arranged on the PCI unit 940. The flow control unit may orchestrate computations done by the vector operation unit 950 and logic units 925 based on a timing sequence of operations in the DNN model. An example of the flow control unit is the flow control unit 111 in FIG. 1. As another example, a decrypt unit may be arranged on the PCI unit 940. The decrypt unit may decrypt data received by the 3D integrated system 900. The decrypt unit can ensure secure communication of the 3D integrated system 900.

The fabric 960 facilitates communications within the 3D integrated system 900. The fabric 960 may be connected to the PCI unit 940, vector operation unit 950, logic units 925, and adders 965. In some embodiments, the fabric 960 may facilitate transfer of data computed by the vector operation unit 950 to the logic units 925. The fabric 960 may also facilitate transfer of data computed by the logic units 925 to the adders 965. The fabric 960 may further facilitate transfer of data computed by an adder 965 to another adder 965. In some embodiments, the adders 965 may be arranged in a sequence. In an example, the adder 965 that is the furthest from the vector operation unit 950 is the first adder of the sequence, while the adder 965 that is the closest to the vector operation unit 950 is the last adder in the sequence. The first adder may receive data points computed by two or more logic units 925 and compute a sum of the data points. The sum may be provided to the second adder, which may then compute a new sum from the sum computed by the first adder and one or more data points computed by one or more other logic units 925. This may continue till the last adder compute a final output data point or an intermediate sum that is to be further summed with other data points.

The memory layer 910 and logic layer 920 constitute a 3D structure, in which high-density memory modules in the memory layer 910 are positioned directly above the logic layer 920. These memory modules can provide local, high-speed data storage, minimizing the distance data needs to travel and thus reducing latency. The memory layer 910 and logic layer 920 are interconnected through the TSVs 930. The TSVs 930 can provide vertical interconnections that link the memory modules in the top layer with the multiply-accumulate (MAC) units in the bottom layer. The TSV 930 can facilitate high-bandwidth, low-latency data transfer between the memory and compute units, effectively eliminating the memory wall. Even though the memory layer 910 is on top of the logic layer 920 in FIG. 9, the logic layer 920 may be on top in other embodiments.

The 3D integrated system 900 is an example of novel 3D-integrated compute and memory systems that are specifically designed to accelerate operations in DNNs such as transformers. In some embodiments, the 3D integrated system 900 may be fabricated by bonding a DRAM wafer directly on top of a logic wafer. After diced, each chip stack may include high-density memory on the top layer and specialized compute logic on the bottom layer, interconnected by TSVs. FIG. 9 shows a vertical integration of these components, highlighting the compact and efficient design. The logic layer may include advanced vector operation units and MAC units tailored for transformer-related processing steps such as activation, normalization, and rotary embedding. By placing memory and compute units in close proximity within a single die, the design can minimize data transfer latencies and power consumption, effectively eliminating the memory wall. This configuration can not only enhance computational speed but also boosts energy efficiency, making it ideal for applications requiring real-time processing, such as edge computing, mobile devices, and Internet of Things (IoT) systems. The modular nature of the chip stacks allows for scalable deployment, adaptable to various computational demands and future technological advancements. The system can scale efficiently with large models (e.g., LLMs), leveraging the transformer architecture, and ensure that weights remain within individual dies while only the activation vectors are transferred. This can require minimal bandwidth, allowing for low-bandwidth die-to-die connections and enabling the system to grow seamlessly with increasing model sizes. FIG. 9 provides a visual representation of the interconnected layers and the efficient use of space, further showing the optimization of deep learning model computations.

Certain aspects of hardware implementing models on silicon are further described in U.S. patent application Ser. No. 19/281,006, filed on Jul. 25, 2025, U.S. patent application Ser. No. 19/275,640, filed on Jul. 21, 2025, U.S. patent application Ser. No. 19/244,318, filed on Jun. 20, 2025, International Patent Application No. PCT/US2025/055412, filed on Nov. 13, 2025, and International Patent Application No. PCT/US2025/055352, filed on Nov. 13, 2025, each of which is hereby incorporated by reference in its entirety.

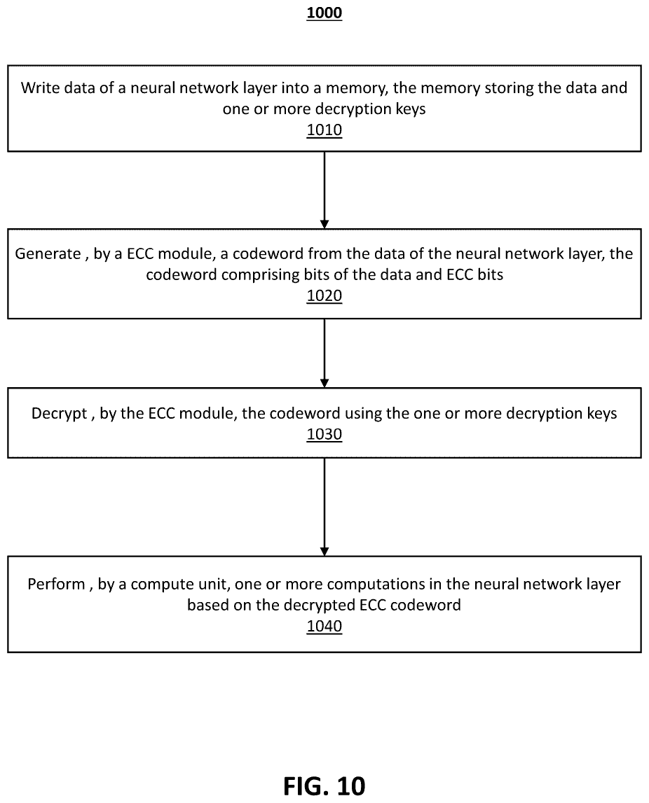

FIG. 10 is a flowchart showing a method 1000 of DNN inference, in accordance with various embodiments. The method 1000 may be performed by the ASIC wafer 320 in FIG. 6. Although the method 1000 is described with reference to the flowchart illustrated in FIG. 10, many other methods for DNN inference may alternatively be used. For example, the order of execution of the steps in FIG. 10 may be changed. As another example, some of the steps may be changed, eliminated, or combined.

The ASIC wafer 320 writes 1010 data of a neural network layer into a memory. The memory stores the data and one or more decryption keys. In some embodiments, the memory is in a wafer located above the ASIC wafer 320. For instance, the memory is in the DRAM wafer 310 in FIG. 3. In some embodiments, the memory comprises one or more fuses storing the one or more decryption keys and one or more other decryption keys. The one or more decryption keys are specific to the neural network layer. The one or more other decryption keys are specific to one or more other neural network layers. In some embodiments, the one or more decryption keys and one or more other decryption keys are generated by segmenting a neural network model into the neural network layer and the one or more other neural network layers and encrypting the neural network layer and the one or more other neural network layers.

The ASIC wafer 320 generates 1020, by an ECC module, a codeword from the data of the neural network layer. The codeword comprises bits of the data and ECC bits. In some embodiments, the ECC module is the ECC module 329A in FIG. 3, ECC module 329B in FIG. 3, or ECC module 600 in FIG. 6. In some embodiments, the ASIC wafer 320 generates, by an encoder of the ECC module, parity bits from the data of the neural network layer. The ASIC wafer 320, by the encoder of the ECC module, combines the parity bits with bits of the data to generate the codeword.

The ASIC wafer 320 decrypts 1030, by the ECC module, the codeword using the one or more decryption keys. In some embodiments, the ASIC wafer 320 transmits the decrypted ECC codeword from a register to the decoder of the ECC module through a number of clocked cycles. The number of clock cycles equals a number of bits in the ECC codeword. In some embodiments, the error is a single-bit error. The ASIC wafer 320 corrects the error by identifying a bit in the data of the neural network layer based on the decrypted ECC codeword and flipping the identified bit. In some embodiments, the ASIC wafer 320 detects, by the decoder of the ECC module, a multi-bit error based on the decrypted ECC codeword. The ASIC wafer 320 bypasses correction of the multi-bit error.

The ASIC wafer 320 performs 1040, by a compute unit, one or more computations in the neural network layer based on the decrypted ECC codeword. In some embodiments, the ASIC wafer 320 writes the decrypted ECC codeword into the memory. The ASIC wafer 320 reads the data of the neural network layer from the memory after the decrypted ECC codeword is written into the memory. The ASIC wafer 320 corrects, by a decoder of the ECC module, an error associated with the data of the neural network layer based on the decrypted ECC codeword to generate corrected data. The one or more computations in the neural network layer are performed using the corrected data.

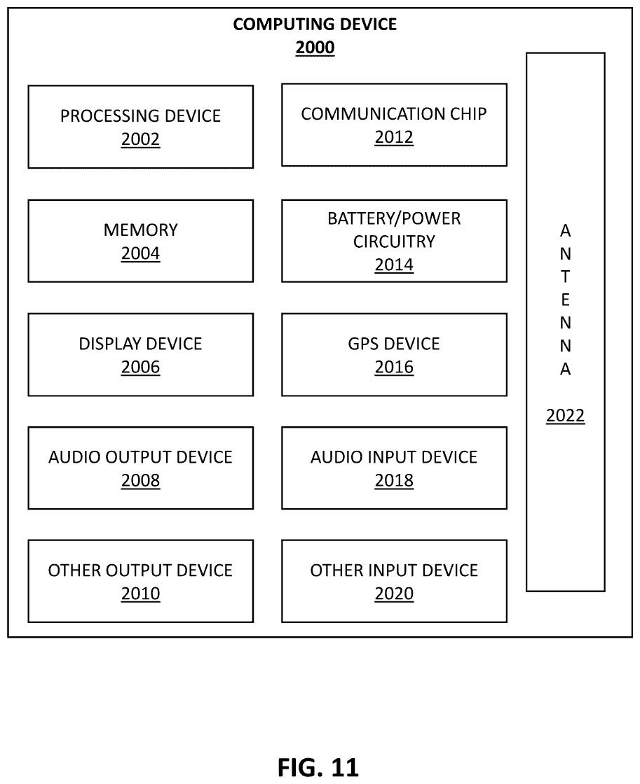

FIG. 11 is a block diagram of an example computing device 2000, in accordance with various embodiments. The computing device 2000 may implement at least part of the DNN inference system 700 in FIG. 7. A number of components are illustrated in FIG. 11 as included in the computing device 2000, but any one or more of these components may be omitted or duplicated, as suitable for the application. In some embodiments, some or all of the components included in the computing device 2000 may be attached to one or more motherboards. In some embodiments, some or all of these components are fabricated onto a single system-on-a-chip (SoC) die. Additionally, in various embodiments, the computing device 2000 may not include one or more of the components illustrated in FIG. 11, but the computing device 2000 may include interface circuitry for coupling to the one or more components. For example, the computing device 2000 may not include a display device 2006, but may include display device interface circuitry (e.g., a connector and driver circuitry) to which a display device 2006 may be coupled. In another set of examples, the computing device 2000 may not include an audio input device 2018 or an audio output device 2008 but may include audio input or output device interface circuitry (e.g., connectors and supporting circuitry) to which an audio input device 2018 or audio output device 2008 may be coupled.

The computing device 2000 may include a processing device 2002 (e.g., one or more processing devices). The processing device 2002 processes electronic data from registers and/or memory to transform that electronic data into other electronic data that may be stored in registers and/or memory. The computing device 2000 may include a memory 2004, which may itself include one or more memory devices such as volatile memory (e.g., DRAM), non-volatile memory (e.g., ROM, HBM, flash memory, solid state memory, and/or a hard drive. In some embodiments, the memory 2004 may include memory that shares a die with the processing device 2002. In some embodiments, the memory 2004 includes one or more non-transitory computer-readable media storing instructions executable to perform operations for DNN inference, such as operations performed by the integrated memory-compute system 300 in FIG. 3 (e.g., operation performed by the ASIC wafer 320) or the method 1000 described above in conjunction with FIG. 10. The instructions stored in the one or more non-transitory computer-readable media may be executed by the processing device 2002.

In some embodiments, the computing device 2000 may include a communication chip 2012 (e.g., one or more communication chips). For example, the communication chip 2012 may be configured for managing wireless communications for the transfer of data to and from the computing device 2000. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not.

The communication chip 2012 may implement any of a number of wireless standards or protocols, including but not limited to Institute for Electrical and Electronic Engineers (IEEE) standards including Wi-Fi (IEEE 802.10 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication chip 2012 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication chip 2012 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 2012 may operate in accordance with Code-division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 2012 may operate in accordance with other wireless protocols in other embodiments. The computing device 2000 may include an antenna 2022 to facilitate wireless communications and/or to receive other wireless communications (such as AM or FM radio transmissions).

In some embodiments, the communication chip 2012 may manage wired communications, such as electrical, optical, or any other suitable communication protocols (e.g., the Ethernet). As noted above, the communication chip 2012 may include multiple communication chips. For instance, a first communication chip 2012 may be dedicated to shorter-range wireless communications such as Wi-Fi or Bluetooth, and a second communication chip 2012 may be dedicated to longer-range wireless communications such as global positioning system (GPS), EDGE, GPRS, CDMA, WiMAX, LTE, EV-DO, or others. In some embodiments, a first communication chip 2012 may be dedicated to wireless communications, and a second communication chip 2012 may be dedicated to wired communications.

The computing device 2000 may include battery/power circuitry 2014. The battery/power circuitry 2014 may include one or more energy storage devices (e.g., batteries or capacitors) and/or circuitry for coupling components of the computing device 2000 to an energy source separate from the computing device 2000 (e.g., AC line power).

The computing device 2000 may include a display device 2006 (or corresponding interface circuitry, as discussed above). The display device 2006 may include any visual indicators, such as a heads-up display, a computer monitor, a projector, a touchscreen display, a liquid crystal display (LCD), a light-emitting diode display, or a flat panel display, for example.

The computing device 2000 may include an audio output device 2008 (or corresponding interface circuitry, as discussed above). The audio output device 2008 may include any device that generates an audible indicator, such as speakers, headsets, or earbuds, for example.

The computing device 2000 may include an audio input device 2018 (or corresponding interface circuitry, as discussed above). The audio input device 2018 may include any device that generates a signal representative of a sound, such as microphones, microphone arrays, or digital instruments (e.g., instruments having a musical instrument digital interface (MIDI) output).

The computing device 2000 may include a GPS device 2016 (or corresponding interface circuitry, as discussed above). The GPS device 2016 may be in communication with a satellite-based system and may receive a location of the computing device 2000, as known in the art.

The computing device 2000 may include another output device 2010 (or corresponding interface circuitry, as discussed above). Examples of the other output device 2010 may include an audio codec, a video codec, a printer, a wired or wireless transmitter for providing information to other devices, or an additional storage device.

The computing device 2000 may include another input device 2020 (or corresponding interface circuitry, as discussed above). Examples of the other input device 2020 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 2000 may have any desired form factor, such as a handheld or mobile computer system (e.g., a cell phone, a smart phone, a mobile internet device, a music player, a tablet computer, a laptop computer, a netbook computer, an ultrabook computer, a personal digital assistant (PDA), an ultramobile personal computer, etc.), a desktop computer system, a server or other networked computing component, a printer, a scanner, a monitor, a set-top box, an entertainment control unit, a vehicle control unit, a digital camera, a digital video recorder, or a wearable computer system. In some embodiments, the computing device 2000 may be any other electronic device that processes data.

The following paragraphs provide various examples of the embodiments disclosed herein.

Example 1 provides an apparatus for neural network inference, the apparatus including a memory to store data of a neural network layer and one or more decryption keys; an error-correcting code (ECC) module to: generate an ECC codeword from the data of the neural network layer, and decrypt the ECC codeword using the one or more decryption keys; and a compute unit to perform one or more computations in the neural network layer based on the decrypted ECC codeword.

Example 2 provides the apparatus of example 1, in which the ECC module includes an encoder and a decoder, in which the encoder is to generate the ECC codeword and to decrypt the ECC codeword, and in which the decoder is to detect or correct an error associated with the data of the neural network layer based on the ECC codeword.

Example 3 provides the apparatus of example 2, in which the ECC module further includes a shift register, in which the ECC codeword is transmitted from the shift register to the decoder through a number of clocked cycles, in which the number of clock cycles equals a number of bits in the ECC codeword.

Example 4 provides the apparatus of example 2 or 3, in which the error is a single-bit error, in which the decoder is to correct the single-bit error by identifying a bit in the data of the neural network layer and flipping the identified bit.

Example 5 provides the apparatus of any one of examples 2-4, in which the error is a multi-bit error, in which the decoder is to detect the multi-bit error and to bypass correcting the multi-bit error.

Example 6 provides the apparatus of any one of examples 2-5, in which the encoder is to generate the ECC codeword and to decrypt the data of the neural network layer when the data of the neural network layer is written into the memory, in which the decoder is to detect or correct the error when the data of the neural network layer is read from the memory to the compute unit.

Example 7 provides the apparatus of any one of examples 1-6, in which the memory includes one or more fuses storing the one or more decryption keys and one or more other decryption keys, the one or more decryption keys corresponding to the neural network layer, the one or more other decryption keys corresponding to one or more other neural network layers.

Example 8 provides the apparatus of example 7, in which the one or more decryption keys and one or more other decryption keys are generated by segmenting a neural network model into the neural network layer and the one or more other neural network layers and encrypting the neural network layer and the one or more other neural network layers.

Example 9 provides the apparatus of any one of examples 1-8, in which the ECC module is further to write the decrypted ECC codeword into the memory.

Example 10 provides the apparatus of any one of examples 1-9, further including a plurality of memory banks, in which the memory is a memory bank of the plurality of memory banks; and a plurality of compute units including the computer unit, in which each of the plurality of compute units is coupled with a different one of the plurality of memory banks, the plurality of compute units to perform computations in the neural network layer in parallel.

Example 11 provides the apparatus of example 10, in which the plurality of memory banks are in one or more memory layers, and in which the plurality of compute units and the ECC module are in a logic layer, the memory layer stacked over the logic layer.

Example 12 provides the apparatus of example 11, in which the one or more memory layers are coupled to the logic layer through a plurality of through-silicon vias.

Example 13 provides one or more non-transitory computer-readable media storing instructions executable to perform operations for neural network inference, the operations including writing data of a neural network layer into a memory, the memory storing the data and one or more decryption keys; generating, by an error-correcting code (ECC) module, a codeword from the data of the neural network layer, the codeword including bits of the data and ECC bits; decrypting, by the ECC module, the codeword using the one or more decryption keys; and performing, by a compute unit, one or more computations in the neural network layer based on the decrypted ECC codeword.

Example 14 provides the one or more non-transitory computer-readable media of example 13, in which the operations further include writing the decrypted ECC codeword into the memory; reading the data of the neural network layer from the memory after the decrypted ECC codeword is written into the memory; and correcting, by a decoder of the ECC module, an error associated with the data of the neural network layer based on the decrypted ECC codeword to generate corrected data, in which the one or more computations in the neural network layer are performed using the corrected data.

Example 15 provides the one or more non-transitory computer-readable media of example 14, in which the operations further include transmitting the decrypted ECC codeword from a register to the decoder of the ECC module through a number of clocked cycles, in which the number of clock cycles equals a number of bits in the ECC codeword.

Example 16 provides the one or more non-transitory computer-readable media of example 14 or 15, in which the error is a single-bit error, in which correcting the error including identifying a bit in the data of the neural network layer based on the decrypted ECC codeword; and flipping the identified bit.

Example 17 provides the one or more non-transitory computer-readable media of example 16, in which the operations further include detecting, by the decoder of the ECC module, a multi-bit error based on the decrypted ECC codeword; and bypassing correction of the multi-bit error.

Example 18 provides the one or more non-transitory computer-readable media of any one of examples 13-17, in which the memory includes one or more fuses storing the one or more decryption keys and one or more other decryption keys, the one or more decryption keys corresponding to the neural network layer, the one or more other decryption keys corresponding to one or more other neural network layers.

Example 19 provides the one or more non-transitory computer-readable media of example 18, in which the one or more decryption keys and one or more other decryption keys are generated by segmenting a neural network model into the neural network layer and the one or more other neural network layers and encrypting the neural network layer and the one or more other neural network layers.

Example 20 provides an apparatus for neural network inference, the apparatus including a memory layer including a plurality of memory banks, a memory bank to store data of a neural network layer and one or more decryption keys; and a logic layer including an error-correcting code (ECC) module and a plurality of compute units, the ECC module to generate an ECC codeword from the data of the neural network layer and to decrypt the ECC codeword using the one or more decryption keys, a compute unit coupled with the memory bank, the compute unit to perform one or more computations in the neural network layer based on the decrypted ECC codeword.

Example 21 provides the apparatus of example 20, in which the ECC module includes an encoder and a decoder, in which the encoder is to generate the ECC codeword and to decrypt the ECC codeword, in which the decoder is to detect or correct an error associated with the data of the neural network layer based on the ECC codeword.

Example 22 provides the apparatus of example 21, in which the ECC module further includes a shift register, in which the ECC codeword is transmitted from the shift register to the decoder through a number of clocked cycles, in which the number of clock cycles equals a number of bits in the ECC codeword.

Example 23 provides the apparatus of any one of examples 20-22, in which the memory layer includes one or more fuses storing the one or more decryption keys and one or more other decryption keys, the one or more decryption keys corresponding to the neural network layer, the one or more other decryption keys corresponding to one or more other neural network layers.

Example 24 provides the apparatus of example 23, in which the one or more decryption keys and one or more other decryption keys are generated by segmenting a neural network model into the neural network layer and the one or more other neural network layers and encrypting the neural network layer and the one or more other neural network layers.

Example 25 provides the apparatus of any one of examples 20-24, further including a plurality of through-silicon vias between the memory layer and the logic layer, the plurality of through-silicon vias including one or more through-silicon vias between the memory bank and the compute unit.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art can recognize. These modifications may be made to the disclosure in light of the above detailed description.

1. An apparatus for neural network inference, the apparatus comprising:
a memory to store data of a neural network layer and one or more decryption keys;
an error-correcting code (ECC) module to:
generate an ECC codeword from the data of the neural network layer, and
decrypt the ECC codeword using the one or more decryption keys; and
a compute unit to perform one or more computations in the neural network layer based on the decrypted ECC codeword.

2. The apparatus of claim 1, wherein the ECC module comprises an encoder and a decoder, wherein the encoder is to generate the ECC codeword and to decrypt the ECC codeword, and wherein the decoder is to detect or correct an error associated with the data of the neural network layer based on the ECC codeword.

3. The apparatus of claim 2, wherein the ECC module further comprises a shift register, wherein the ECC codeword is transmitted from the shift register to the decoder through a number of clocked cycles, wherein the number of clock cycles equals a number of bits in the ECC codeword.

4. The apparatus of claim 2, wherein the error is a single-bit error, wherein the decoder is to correct the single-bit error by identifying a bit in the data of the neural network layer and flipping the identified bit.

5. The apparatus of claim 2, wherein the error is a multi-bit error, wherein the decoder is to detect the multi-bit error and to bypass correcting the multi-bit error.

6. The apparatus of claim 2, wherein the encoder is to generate the ECC codeword and to decrypt the data of the neural network layer when the data of the neural network layer is written into the memory, wherein the decoder is to detect or correct the error when the data of the neural network layer is read from the memory to the compute unit.

7. The apparatus of claim 1, wherein the memory comprises one or more fuses storing the one or more decryption keys and one or more other decryption keys, the one or more decryption keys corresponding to the neural network layer, the one or more other decryption keys corresponding to one or more other neural network layers.

8. The apparatus of claim 7, wherein the one or more decryption keys and one or more other decryption keys are generated by segmenting a neural network model into the neural network layer and the one or more other neural network layers and encrypting the neural network layer and the one or more other neural network layers.

9. The apparatus of claim 1, wherein the ECC module is further to write the decrypted ECC codeword into the memory.

10. The apparatus of claim 1, further comprising:
a plurality of memory banks, wherein the memory is a memory bank of the plurality of memory banks; and
a plurality of compute units including the computer unit,
wherein each of the plurality of compute units is coupled with a different one of the plurality of memory banks, the plurality of compute units to perform computations in the neural network layer in parallel.

11. The apparatus of claim 10, wherein the plurality of memory banks are in one or more memory layers, and wherein the plurality of compute units and the ECC module are in a logic layer, the memory layer stacked over the logic layer.

12. The apparatus of claim 11, wherein the one or more memory layers are coupled to the logic layer through a plurality of through-silicon vias.

13. One or more non-transitory computer-readable media storing instructions executable to perform operations for neural network inference, the operations comprising:
writing data of a neural network layer into a memory, the memory storing the data and one or more decryption keys;
generating, by an error-correcting code (ECC) module, a codeword from the data of the neural network layer, the codeword comprising bits of the data and ECC bits;
decrypting, by the ECC module, the codeword using the one or more decryption keys; and
performing, by a compute unit, one or more computations in the neural network layer based on the decrypted ECC codeword.

14. The one or more non-transitory computer-readable media of claim 13, wherein the operations further comprise:
writing the decrypted ECC codeword into the memory;
reading the data of the neural network layer from the memory after the decrypted ECC codeword is written into the memory; and
correcting, by a decoder of the ECC module, an error associated with the data of the neural network layer based on the decrypted ECC codeword to generate corrected data,
wherein the one or more computations in the neural network layer are performed using the corrected data.

15. The one or more non-transitory computer-readable media of claim 14, wherein the operations further comprise:
transmitting the decrypted ECC codeword from a register to the decoder of the ECC module through a number of clocked cycles, wherein the number of clock cycles equals a number of bits in the ECC codeword.

16. The one or more non-transitory computer-readable media of claim 14, wherein the error is a single-bit error, wherein correcting the error comprising:
identifying a bit in the data of the neural network layer based on the decrypted ECC codeword; and
flipping the identified bit.

17. The one or more non-transitory computer-readable media of claim 16, wherein the operations further comprise:
detecting, by the decoder of the ECC module, a multi-bit error based on the decrypted ECC codeword; and
bypassing correction of the multi-bit error.

18. The one or more non-transitory computer-readable media of claim 13, wherein the memory comprises one or more fuses storing the one or more decryption keys and one or more other decryption keys, the one or more decryption keys corresponding to the neural network layer, the one or more other decryption keys corresponding to one or more other neural network layers.

19. The one or more non-transitory computer-readable media of claim 18, wherein the one or more decryption keys and one or more other decryption keys are generated by segmenting a neural network model into the neural network layer and the one or more other neural network layers and encrypting the neural network layer and the one or more other neural network layers.

20. An apparatus for neural network inference, the apparatus comprising:
a memory layer comprising a plurality of memory banks, a memory bank to store data of a neural network layer and one or more decryption keys; and
a logic layer comprising an error-correcting code (ECC) module and a plurality of compute units, the ECC module to generate an ECC codeword from the data of the neural network layer and to decrypt the ECC codeword using the one or more decryption keys, a compute unit coupled with the memory bank, the compute unit to perform one or more computations in the neural network layer based on the decrypted ECC codeword.

21. The apparatus of claim 20, wherein the ECC module comprises an encoder and a decoder, wherein the encoder is to generate the ECC codeword and to decrypt the ECC codeword, wherein the decoder is to detect or correct an error associated with the data of the neural network layer based on the ECC codeword.

22. The apparatus of claim 21, wherein the ECC module further comprises a shift register, wherein the ECC codeword is transmitted from the shift register to the decoder through a number of clocked cycles, wherein the number of clock cycles equals a number of bits in the ECC codeword.

23. The apparatus of claim 20, wherein the memory layer comprises one or more fuses storing the one or more decryption keys and one or more other decryption keys, the one or more decryption keys corresponding to the neural network layer, the one or more other decryption keys corresponding to one or more other neural network layers.

24. The apparatus of claim 23, wherein the one or more decryption keys and one or more other decryption keys are generated by segmenting a neural network model into the neural network layer and the one or more other neural network layers and encrypting the neural network layer and the one or more other neural network layers.

25. The apparatus of claim 20, further comprising:
a plurality of through-silicon vias between the memory layer and the logic layer, the plurality of through-silicon vias comprising one or more through-silicon vias between the memory bank and the compute unit.
